(19) United States
(12) Patent Application Publication
(10) Pub. No.: US 2019/0309421 A1
(43) Pub. Date: Oct. 10, 2019

(54) SELF-CURING MIXED-METAL OXIDES

(71) Applicant: BRISBANE MATERIALS TECHNOLOGY PTY LTD, Darra, Queensland (AU)

(72) Inventors: Michael HARVEY, Darra (AU); Peter SURAWSKI, Darra (AU)

(21) Appl. No.: 16/309,407

(22) PCT Filed: Jun. 15, 2017
(86) PCT No.: PCT/AU2017/050599

§ 371 Date: Dec. 12, 2018

(30) Foreign Application Priority Data
Jun. 15, 2016 (AU) 2016902320

(51) Int. Cl. C23C 18/12; C03C 17/10; C03C 17/25; C03C 17/27; C03C 17/30; C09D 1/02; C23C 18/08

(52) U.S. Cl. CPC C23C 18/1216; C03C 2218/116; C03C 17/256; C03C 17/27; C03C 17/30; C03C 17/253; C09D 1/02; C23C 18/08; C03C 2217/211; C03C 2217/212; C03C 2217/213; C03C 2217/214; C03C 2217/228; C03C 2217/23; C03C 2217/732; C03C 2217/74; C03C 2218/112; C03C 2218/113; C03C 17/10

(57) ABSTRACT

A process of forming a mixed metal oxide solid is provided. The process includes the steps of obtaining a precursor composition comprising at least two metal or metalloid-containing compounds, the metal or metalloid of the at least two compounds being different, one from the other; and allowing the at least two metal or metalloid-containing compounds of the precursor composition to at least partially react by hydrolysis and/or condensation. The at least two metal or metalloid-containing compounds may have different points of zero charge (PZC). Further material or articles comprising a substrate or material coated with or otherwise in physical connection to the mixed metal oxide solid formed according to the process are also provided.

### TECHNICAL FIELD

THIS invention relates to mixed metal oxide materials. More particularly, the invention relates to solid materials formed from at least two metal or metalloid containing compounds, and a process for producing such materials.

### BACKGROUND

The ‘sol-gel’ process is a method for producing solid materials, such as films, from small molecules. The process typically involves: (i) the formation of a colloid or ‘sol’ from a precursor composition of monomer and/or oligomer compounds in a solvent by hydrolysis and condensation; (ii) optionally allowing the colloid to further react to form a ‘gel’; (iii) coating a substrate with the colloid or the gel; and (iv) removal of the solvent to produce a film on the substrate.

Sol-gel processes generally require one or more steps involving a catalyst or other reagent to induce formation of the sol and/or formation of the gel. Such steps can contribute substantially to the cost and/or complexity of producing films using sol-gel processes. Furthermore, once the sol or colloid is formed it must be used soon after or other stabilising agents must be added to the mixture. These stabilising agents must then carry through the subsequent processing into a film and are often undesirably left in the final film as contaminants.

Additionally, materials made by the sol-gel process are typically quite delicate as synthesised, and so where the material requires structural integrity, cohesion, or adhesion it is then further processed by heating, sintering, or calcination—all of which are high temperature process steps.

### SUMMARY

In a first aspect, the invention provides a process of forming a mixed metal oxide solid including the steps of:

(i) obtaining a precursor composition comprising at least two metal or metalloid-containing compounds, the metal or metalloid of the at least two compounds being different, one from the other; and

(ii) allowing the at least two metal or metalloid-containing compounds of the precursor composition to at least partially react by hydrolysis and/or condensation,

to thereby form the mixed metal oxide solid.

In embodiments, the mixed metal oxide solid is selected from the group consisting of a film, a monolith, a powder, and a suspension. In a particularly preferred embodiment, the solid is a film.

Preferably, the oxides of the at least two metal or metalloid-containing compounds have different points of zero charge (PZC).

Suitably, the precursor composition is a liquid-based composition.

Preferably, the precursor composition further comprises a solvent and/or other carrier liquid.

In certain preferred embodiments, the precursor composition is a solution.

In other embodiments, the precursor composition may be a liquid-based composition that is not a solution, such as a suspension, colloid, or an emulsion.

Preferably, the process of the first aspect does not require exposing the precursor composition comprising the at least two metal or metalloid-containing compounds to a catalyst to induce hydrolysis and/or condensation of the at least two compounds to form the mixed metal oxide solid.

Preferably, the process of the first aspect does not require the addition of agents and/or reagents, other than optionally water, to the precursor solution, to induce hydrolysis and/or condensation of the at least two compounds to form the mixed metal oxide solid. It is particularly preferred that the process of the first aspect does not require the addition of acid and/or alkali to form the mixed metal oxide solid.

In certain embodiments, the metal or metalloids of the at least two metal or metalloid-containing compounds are selected from the group consisting of silicon, germanium, tin, titanium, zirconium, hafnium, vanadium, niobium, tantalum, chromium, cesium, molybdenum, tungsten, yttrium, magnesium, calcium, strontium, barium, lead, zinc, cadmium, mercury, boron, aluminium, gallium, manganese, cerium, iron, tungsten, boron, ytterbium, tellurium, indium, and combinations thereof.

Each of these metal or metalloids may independently be combined, as appropriate, with any suitable compound-forming moieties. In certain embodiments, said moiety is selected from the group consisting of halide, halogen, alkoxide, alkyl, hydroxyl, hydrogen, acyloxy, alkoxy, and acetyl.

In certain preferred embodiments, at least one of said metal or metalloids is silicon or aluminium.

Preferably, at least one of the metal or metalloid-containing compounds has at least two hydrolysable or condensable groups. More preferably, each of the at least two metal or metalloid-containing compounds has at least two hydrolysable or condensable groups.

In one embodiment, each of the at least two metal or metalloid-containing compounds has at least three, preferably at least four hydrolysable or condensable groups.

Preferably, at least one of the metal or metalloid-containing compounds is an alkoxide. In certain embodiments wherein at least one of the metal or metal or metalloid-containing compounds is an alkoxide, said metal or metalloid alkoxide is an oligomer.

The metal or metalloid-containing compounds of the process of this aspect will be those capable of forming a metal or metalloid oxide.

In certain preferred embodiments, step (i) is preceded by a step of combining at least two metal or metalloid-containing compounds, and optionally a solvent and/or other carrier liquid, to form the precursor composition.

In preferred embodiments wherein the precursor solution comprises a solvent, the step of combining may be a step of substantially dissolving the at least two metal or metalloid-containing compounds into the solvent.

Suitably, in embodiments wherein the precursor composition comprises a solvent, step (ii) includes allowing some or all of the solvent to evaporate from the precursor composition, or an intermediate formed therefrom.

Preferably, step (ii) includes exposing the precursor composition, or an intermediate formed therefrom, to elevated temperature.

In preferred embodiments of this aspect, the precursor composition is applied to a further material or substrate. The material or substrate may be one which presents, or can be modified to present, an oxygen atom for bonding to the mixed metal oxide solid.

In these embodiments, preferably the mixed metal oxide solid is a film.

Preferably, the material or substrate is selected from the group consisting of crystalline metal oxides; amorphous metal oxides; sapphire; silicon; germanium; a semiconductor material; plastic; glass including borosilicate glass, silicon glass, float glass, cast glass, rolled glass, and soda-lime glass; acrylics and acrylates such as poly(methyl methacrylate) and polymethyl methacrylimide; polycarbonate; polyester (e.g. polyethylene terephthalate); metals such as aluminium and copper; and elastomers such as silicone.

In embodiments, the at least two metal or metalloid-containing compounds are substantially dissolved in a solvent of the precursor composition at the time said solution is applied to the substrate or material.

In one embodiment, the substrate or material may be pre-coated or treated with a priming layer or an adhesive layer to improve binding of the mixed metal oxide solid.

In one embodiment, one or more of the at least two metal or metalloid-containing compounds is deposited onto a substrate or material and the remaining of the metal or metalloid-containing compounds is subsequently added, e.g. by deposition, or by bringing a second substrate coated with this into contact with the first.

The process of this aspect may include a further step of controlling one or more characteristics of the mixed metal oxide solid by selecting or adjusting certain parameters.

Preferably, in embodiments of the process which include said further step of controlling one or more characteristics of the mixed metal oxide solid by selecting or adjusting certain parameters, said characteristics are selected from the group consisting of physical; morphological; optical; electrical; thermal; and chemical characteristics.

An embodiment of this aspect includes the step of adhering a plurality of materials with the mixed metal oxide solid formed according to the process.

An embodiment of this aspect includes the step of binding a material with the mixed metal oxide solid formed according to the process.

An embodiment of this aspect includes the step of encapsulating a material with the mixed metal oxide solid formed according to the process.

An embodiment of this aspect includes the step of applying a barrier on a material with the mixed metal oxide solid formed according to the process.

An embodiment of this aspect includes the step of adjusting optical properties of a material by combining the mixed metal oxide solid formed according to the process with the material.

An embodiment of this aspect includes the step of morphologically altering the surface of a material by applying the mixed metal oxide solid formed according to the process to the surface of the material.

In a second aspect, the invention provides a mixed metal oxide solid produced according to the first aspect.

In a third aspect, the invention provides a mixed metal oxide solid formed by obtaining a precursor composition comprising at least two metal- or metalloid-containing compounds, wherein the metal or metalloids of the at least two compounds are different, one from the other; and allowing the at least two metal or metalloid-containing compounds of the precursor composition to at least partially hydrolyse and/or condense and react.

In some preferred embodiments, the mixed metal oxide solid of this aspect is applied to a material or substrate such as a crystalline metal oxide; an amorphous metal oxide; sapphire; silicon; germanium; a semiconductor material or substrate; plastic, glass such as borosilicate glass, float glass, cast glass, rolled glass, soda-lime glass; acrylics and acrylates such as poly(methyl methacrylate) and polymethyl methacrylimide; polycarbonate; polyester (e.g. polyethylene terephthalate); metals such as aluminium and copper; and elastomers such as silicone.

In some preferred embodiments, the mixed metal oxide solid of the second or third aspect, or the mixed metal film produced according to the first aspect, is substantially homogenous.

In a fourth aspect, the invention provides a mixed metal oxide solid of the second or third aspect for use or when used for a particular application.

In an embodiment of this aspect the mixed metal oxide solid is for adhering a plurality of materials.

In an embodiment of this aspect the mixed metal oxide solid is for binding a material.

In an embodiment of this aspect the mixed metal oxide solid is for encapsulating a material.

In an embodiment of this aspect the mixed metal oxide solid is for forming a barrier on a material.

In an embodiment of this aspect the mixed metal oxide solid is for adjusting optical properties of a material.

In an embodiment of this aspect the mixed metal oxide solid is for morphologically altering the surface of a material.

In a fifth aspect, the invention provides for a mixed metal oxide solid of the second or third aspects applied to or coated on a further material or substrate.

It will be appreciated that the indefinite articles “a” and “an” are not to be read as singular indefinite articles or as otherwise excluding more than one or more than a single subject to which the indefinite article refers. For example, “a” metal includes one metal, one or more metals or a plurality of metals.

As used herein, unless the context requires otherwise, the words “comprise”, “comprises” and “comprising” will be understood to mean the inclusion of a stated integer or group of integers but not the exclusion of any other integer or group of integers.

### BRIEF DESCRIPTION OF THE FIGURES

In order that the invention may be readily understood and put into practical effect, preferred embodiments will now be described by way of example with reference to the accompanying figures, wherein:

FIG. 1 sets forth a scanning electron microscope (SEM) image of a mixed metal oxide film of the invention formed from a precursor composition comprising a tin-containing compound (tin 2-ethylhexanoate) and a silicon-containing compound (methyl silicate 51); and a solvent mix of butanone and 2-butoxyethanol, coated onto a glass substrate.

FIG. 2 sets forth a SEM image of a mixed metal oxide film of the invention formed from a precursor composition comprising a zirconium-containing compound (zirconium propoxide) and a silicon-containing compound (methyl silicate 51); and a solvent mix of butanone and 2-butoxyethanol, coated onto a glass substrate.

FIG. 3 sets forth a SEM image of a mixed metal oxide film of the invention formed from a precursor composition comprising a boron-containing compound (boron triethoxide) and a silicon-containing compound (methyl silicate 51); and a solvent mix of butanone and 2-butoxyethanol, coated onto a glass substrate.

FIG. 4 sets forth a SEM image of a mixed metal oxide film of the invention formed from a precursor composition comprising a titanium-containing compound (titanium butoxide) and a silicon-containing compound (methyl silicate 51); and a solvent mix of butanone and 2-butoxyethanol, coated onto a glass substrate.

FIG. 5 sets forth a SEM image of a mixed metal oxide film of the invention formed from a precursor composition comprising an aluminium-containing compound (aluminium tri-sec-butoxide) and a silicon-containing compound (methyl silicate 51); and a solvent mix of butanone and 2-butoxyethanol, coated onto a glass substrate.

FIG. 6 sets forth a transmission electron microscope image of a mixed metal oxide film of the invention formed from a precursor composition comprising an aluminium-containing compound (aluminium tri-sec-butoxide) and a silicon-containing compound (methyl silicate 51); and a solvent mix of butanone and 2-butoxyethanol, showing variation in density of the mixed metal film, including a surface layer of increased density.

FIG. 7 sets forth transmittance data after autoclaving of a pure silica metal oxide film produced according to a previous coating process as compared to a mixed metal oxide film produced according to the process of the invention as described in Example 1, said film comprising 95% silica and 5% alumina. When exposed to repeated cycles of autoclave exposure the silica degrades, as seen by its decreasing transmittance, whereas the presence of alumina improves the durability of the material.

FIG. 8 sets forth comparative UV transmittance data through a glass substrate and a glass substrate coated with an approximately 100 nm thick CeO and SiO₂ mixed metal oxide film produced according to the process of the invention. It will be evident that the percent transmittance of UV radiation (less than 380 nm) was substantially lower for the coated substrate than the uncoated substrate.

FIG. 9 sets forth (right) a silver reflector surface of an LED leadframe exposed to sulphur environment for 96 hours (ASTM 809B); and (left) a corresponding silver reflector surface of an LED leadframe spray coated with Si:Al mixed metal oxide layer after exposure to the same ASTM809B test. Note the absence of tarnishing on the treated reflector.

### DETAILED DESCRIPTION

The present invention is at least partially predicated on the recognition of a need for a simplified process for forming mixed metal oxide materials.

It has been surprisingly proven experimentally, as described herein, that precursor compositions comprising compounds containing respective different metal or metalloids, but not compounds which contain only the same metal or metalloids, can form mixed metal oxide solids without the need for a catalyst or other initiating agents being present within the precursor composition.

It will be appreciated that mixed metal oxide solids as described herein comprise a solid network formed as a result of hydrolysis and/or condensation of at least two metal or metalloid-containing compounds.

In this context, it will be understood that the term “solid network” includes within its scope porous networks, and agglomerations of grains or particles, but excludes liquids and gasses. It is preferred that the network of the mixed metal oxide solid of the invention is stable, and highly cross-linked. In some preferred embodiments said mixed metal oxide solid possesses a substantially continuous and uniform, or substantially “homogeneous”, composition. Alternatively, the mixed metal oxide may possess a spatially varying composition.

It will be further appreciated that a mixed metal oxide solid of the invention may comprise metal oxides alone, or in combination with other metal or metalloid-containing compounds such as for example metal nitrides, metal hydroxides, metal hydrates, and metal halides, although without limitation thereto.

Mixed metal oxide solids as described herein may be any suitable solid. By way of non-limiting example, said solid may be selected from the group consisting of a film, a monolith, a powder, and a suspension.

In certain particularly preferred embodiments the solid is a film. It will be understood that, as used herein, a mixed metal oxide “film”, refers to a relatively thin mixed metal oxide solid that is typically coated onto another material or substrate.

### Process for Forming a Metal Oxide Film

In one aspect, the invention provides a process of forming a mixed metal oxide solid including the steps of:

(i) obtaining a precursor composition comprising at least two metal or metalloid-containing compounds, the metal or metalloid of the at least two compounds being different, one from the other; and

(ii) allowing the at least two metal or metalloid-containing compounds of the precursor composition to at least partially react by hydrolysis and/or condensation,

to thereby form the mixed metal oxide solid.

In one embodiment, the precursor composition comprises two metal or metalloid-containing compounds. In other embodiments the precursor composition includes more than two metal or metalloid-containing compounds, including 3, 4, 5, 6, 7, 8, 9, 10, or greater than 10 metal or metalloid-containing compounds.

It will be appreciated that, in embodiments wherein the precursor composition comprises more than two metal or metalloid-containing compounds, at least two of said metal or metalloid-containing compounds contain respective different metal or metalloids. That is, it is not necessary that all of the metal or metalloid-containing compounds of a precursor composition comprising more than two metal or metalloid-containing compounds contain respective different metals or metalloids.

Preferably, the at least two metal or metalloid-containing compounds and/or the oxides formed from these metal or metalloid-containing compounds have different points of zero charge (PZC) (alternatively referred to as zero point of charge; ZPC).

As will be understood by the skilled person, PZC of a material may be considered related, but is not identical, to both isoelectric point and the zeta potential. According to a formal IUPAC definition, “a surface charge is at its point of zero charge when the surface charge density is zero. It is a value of the negative logarithm of the activity in the bulk of the charge-determining ions” (IUPAC. Compendium of Chemical Terminology, 2nd ed, Compiled by A. D. McNaught and A. Wilkinson. Blackwell Scientific Publications, Oxford (1997).

A standard literature definition of PZC, and its relationship with isoelectric point, is provided by ‘Aqueous Surface Chemistry of Oxides and Complex Oxide Minerals’, George A. Parks, Equilibrium Concepts in Natural Water Systems. Jan. 1, 1967, 121-160, wherein it is stated:

The isoelectric point (IEP(s)) and the zero point of charge (ZPC) are convenient references for predicting the charge-dependent behavior of oxide minerals and their suspensions. The ZPC is the pH at which the solid surface charge from all sources is zero. The IEP(s) is a ZPC arising from interaction of H+, OH—, the solid, and water alone. The IEP(s) of a simple oxide is related to the appropriate cationic charge and radius. The ZPC of a complex oxide is approximately the weighted average of the IEP(s)'s of its components. Predictable shifts in ZPC occur in response to specific adsorption and to changes in cation coordination, crystallinity, hydration state, cleavage habit, surface composition, and structural charge or ion exchange capacity.

Generally, as used herein, the point of zero charge (PZC) of a particular substance or agent, such as a metal, metalloid, or a compound containing a metal or metalloid, can be understood to be the condition where the surface charge of the substance or agent is neutralised as measured in pH units.

In solution-processed chemistries the charge neutralisation condition is most readily understood in terms of aqueous conditions where the PZC occurs when the pH of the aqueous environment is such that surface of the metal oxide with its solvation shell exhibits no net charge. However, it will be nevertheless be understood that in non-aqueous environments such as those of preferred embodiments described herein, the pH units of the PZC values do not refer directly to the in situ reaction environment. Instead, PZC can be understood as a measure of the propensity for two (or more) metal oxide precursors to interact.

It will be appreciated by the skilled person that PZC of a given substance or agent is typically determined experimentally, rather than theoretically. Various methods for the experimental determination of PZC exist and are known to the skilled person. Common methods that are suitable for calculating PZC values in the context of the present invention include ‘potentiometric titration’, ‘ion absorption’, and ‘pH shift titration’. For exemplary protocols and a comparison of these methods, the skilled person is directed to Appel et al. (2003) ‘Point of zero charge determination in soils and minerals via traditional methods and detection of electroacoustic mobility’, Geoderma, Volume 113, 1-2, 77-93, incorporated herein by reference. It will be appreciated that while Appel et al., supra, calculates PZC in the context of naturally occurring minerals, the techniques as described therein are applicable to synthesised compounds such as those described herein.

By way of further specific example, PZC values as determined for some common metal or metalloid-containing compounds are set forth in Table 7. The skilled person will appreciate that the PZC of a metal or metalloid-containing compound may be primarily influenced by the metal or metalloid of the compound.

Without being bound by theory, it is believed that a difference in PZC is responsible for the formation of mixed metal oxide solids as described herein. In this respect, as set forth in the Examples, formation of a mixed metal oxide solid as per the process described herein has not been observed to occur when the precursor composition includes only a single metal or metalloid-containing compound, or more than one metal or metalloid-containing compound, wherein said compounds contain the same metal or metalloid and have substantially the same PZC. By way of example, it has been found that precursor compositions including only silicon as the metalloid, in combination with methoxy and ethoxy ligands, do not form a mixed metal oxide solids as per the process described herein. Similarly, precursor compositions including only aluminium as the metal, in combination with various substituted ligands, do not form a mixed metal oxide film as per the process described herein.

It is further believed that the magnitude of difference in PZC affects the formation (e.g. reaction of precursors) or properties of mixed metal oxide solids formed according to the process described herein. In this respect, particular reference is made to the results set forth in Example 8. It will be appreciated that the time taken for thin films formed according to preferred embodiments of the process of this aspect to crack was related to the degree of difference in PZC. Furthermore, it will be appreciated that the time taken to form solid monoliths according to preferred embodiments of the process of this aspect was inversely related to the degree of difference in PZC.

It will be appreciated that in embodiments wherein the at least two metal or metalloid-containing compounds have different PZC, and the precursor composition comprises more than two metal or metalloid-containing compounds, providing that two of the metal or metalloid-containing compounds have different PZC, other compounds which may have substantially the same PZC as one of said two compounds can also be incorporated into the mixed metal oxide film produced according to the process of this aspect.

Suitably, the precursor composition according to this aspect is a liquid-based composition. Preferably, the precursor composition further comprises a solvent and/or other carrier liquid.

A range of solvents and/or carrier liquids may be suitable according to the process of this aspect. As used herein, the term “solvent” may refer to any liquid which can solubilize at least one and, preferably, the at least two metal or metalloid-containing compounds and, preferably, is subsequently or during the process relatively easily removed from the solid network of the forming or formed mixed metal oxide film. It will be appreciated that the particular solvent or solvent mix selected, and/or the content of the solvent in the precursor composition, may be varied according to the particular metal or metalloid-containing compounds selected according to the process of this aspect. It will be further appreciated that, in embodiments wherein the precursor composition is applied to or coated onto a further material or substrate as hereinbelow described, the particular solvent or solvent mix selected, and/or the content of the solvent in the precursor composition, may be varied according to the particular wetting or compatibility of the material or substrate.

As used herein, a “carrier liquid” may refer to any liquid within which a metal-containing compound of the invention can be suspended, such as in a colloid, suspension, or emulsion as herein described, and which, preferably, is subsequently or during the process relatively easily removed from the solid network of the forming or formed mixed metal oxide solid. It will readily appreciated by the skilled person that an agent that is a solvent for certain metal or metalloid-containing compounds may be a carrier liquid for other metal or metalloid-containing compounds, or for products of the reactions.

In preferred embodiments wherein the precursor composition comprises a solvent, the solvent is selected from the group consisting of polar solvents, aromatic solvents, alcohols (inclusive of polyols), ketones, alkanes including haloalkanes, amides, ethers (including glycol ethers, diethyl ether and bibutyl ether), aromatic hydrocarbons, halogenated solvents, and esters including PGME, PGMEA, glycol ethers, DMSO, HMDSO, DCM, chlorobenzene, tetrahydrofuran, dichlorobenzene, toluene, various compounds of the benzene/toluene family or mixtures thereof.

Preferably, the solvent comprises an alcohol.

In certain preferred embodiments, the precursor composition is a solution of the metal or metalloid-containing compounds dissolved in a solvent.

As used herein, a “solution” will be understood to be a homogenous, single-phase liquid system. It will be appreciated, however, that during formation of the mixed metal oxide solid from a precursor composition that is a solution, as per the process of embodiments of this aspect, intermediates may form which are not solutions per se, but instead may comprise a phase formed as a result of the at least partial hydrolysis and reaction of the one or more metal or metalloid-containing compounds.

In other embodiments, the precursor composition may be a liquid-based composition that is not a solution, such as a colloid, emulsion, suspension, or a mixture. By way of non-limiting example, an aluminium precursor such as aluminium-sec-butoxide in 2-butoxyethanol may be combined with a silica precursor such as dimethoxypolysiloxane in ethanol such that the ratio of Al:Si is approximately 1:4, and the total concentration by mass of the metal-containing components is approximately 10%. Within a few minutes of combining these components the mixture will form an emulsion. This emulsion can be used directly to create a mixed metal oxide solid or film, e.g. by depositing onto a substrate and allowing the alcohols to evaporate with or without heating, thus causing the reactions to proceed. Alternatively, ethanol or another suitable solvent may be added to the emulsion and thus convert it to a solution which then may be used to form a mixed metal oxide by the methods described below.

Although precursor compositions as described herein will generally not be aqueous, i.e. water will not be the primary solvent, some water will typically be present during formation of mixed metal oxide solids according to the process of this aspect. That is, preferably, the amount of water present during formation of a mixed metal oxide solid according to the process of this aspect is greater than 0% w/w.

It will be appreciated that hydrolysis as per the process of this aspect requires water, and that condensation as per the process of this aspect may, but need not necessarily, require water. It will be further understood that the precursor composition of this aspect will generally be prepared in ambient conditions and so may naturally comprise some water. As used in this context water that the precursor composition “naturally” comprises, will be understood to include water absorbed by metal containing compounds and/or the solvent(s) and/or carrier liquid(s) if present, and/or which has condensed from humidity in the air. It will also be understood that commercially available solvents are commonly not fully dry and often contain some amount of water.

In embodiments wherein additional water is added to the precursor solution, it is desirable that the quantity of said additional water is suitably controlled. It will be appreciated that excess water content in the precursor composition may negatively affect properties of the mixed metal oxide film, e.g. morphological structure and/or stability. Furthermore, uncontrolled addition of water may affect the repeatability of the process.

In one embodiment, the precursor composition consists of, or consists essentially of, the at least two metal or metalloid-containing compounds, and any water naturally present in the precursor composition.

In another embodiment, the precursor composition consists of, or consists essentially of, the at least two metal or metalloid-containing compounds, and a solvent and/or carrier liquid, and any water naturally present in the precursor composition.

In another embodiment, the precursor composition consists of, or consists essentially of, the at least two metal or metalloid-containing compounds, a solvent and/or carrier liquid, and added water.

Preferably, the amount of water present during formation of the mixed metal oxide solid is less than about 10% w/w. More preferably, said amount of water is less than about 1% w/w. In certain particularly preferred embodiments, said amount of water is less than about 0.2% w/w.

In yet other embodiments, the precursor composition may comprise suitable additives, such as hereinbelow described. Preferably, said additives do not include acid and/or alkali additives such as are required for formation of films as per conventional sol-gel processes.

Preferably, the process of the this aspect does not require the addition of agents other than the components of the precursor composition to induce the reaction by hydrolysis and/or condensation of the at least two metal or metalloid-containing compounds for formation of the mixed metal oxide solid.

It is particularly preferred that the process of this aspect does not require exposing the precursor composition comprising the at least two metal or metalloid-containing compounds to a catalyst to induce the reaction by hydrolysis and/or condensation of the at least two metal or metalloid-containing compounds for formation of the mixed metal oxide solid. It is further particularly preferred that the process of this aspect does not require the addition of acid and/or alkali for formation of the mixed metal oxide solid.

Metal or metalloids of the respective at least two metal or metalloid-containing compounds may be chosen from a wide range of elements selected from the periodic table groups 1, 2, 3, 4, 5, 6, 7, 8, 9, 10, 11, 12, 13, 14, 15, or 16.

In certain embodiments, said metal or metalloids are selected from the group consisting of silicon, germanium, tin, titanium, zirconium, hafnium, vanadium, niobium, tantalum, chromium, cesium, molybdenum, tungsten, yttrium, magnesium, calcium, strontium, barium, lead, zinc, cadmium, mercury, boron, aluminium, gallium, manganese, cerium, iron, tungsten, boron, ytterbium, tellurium, indium, and combinations thereof.

Preferably, at least one of said metal or metalloids is silicon or aluminium. It will be appreciated that compounds containing silicon generally have relatively low PZC, as compared to corresponding compounds containing most other metals or metalloids. It will be further appreciated that compounds containing aluminium have relatively high PZC, as compared to corresponding compounds containing most other metals or metalloids. Therefore, silicon and aluminium-containing compounds can be combined with a wide range of other metal or metalloid-containing compounds, wherein a substantial difference in PZC between the compounds exists.

The relative amounts or concentrations of the at least two metal or metalloid-containing compounds in the precursor composition may be the same or different according to the process of this aspect. The relative amounts or concentrations of the metal or metalloids of the at least two metal or metalloid-containing compounds in the precursor composition may also be the same or different according to the process of this aspect.

Suitably, said relative amounts or concentrations fall within a range that facilitates effective formation of a mixed metal oxide solid. Said relative amounts or concentrations may be, at least in part, dependent on the particular metal or metalloid-containing compounds used for the process of this aspect.

Preferably, the relative molar concentration of said compounds is between about 1:1 to about 1:2000, including about: 1:100; 1:200; 1:300; 1:400; 1:500; 1:600; 1:700; 1:800; 1:900; 1:1000; 1:1100; 1:1200; 1:1300; 1:1400; 1:1500; 1:1600; 1:1700; 1:1800; and 1:1900.

In some embodiments, the relative molar range is between about 1:1 and about 1:200; including about: 1:10; 1:20; 1:30; 1:40; 1:50; 1:60; 1:70; 1:80:1:90; 1:100; 1:110; 1:120; 1:130; 1:140; 1:150; 1:160; 1:170; 1:180; and 1:190.

In some embodiments, the relative molar range is between about 1:1 and about 1:10, including about: 1:2; 1:3; 1:4; 1:5; 1:6; 1:7; 1:8; and 1:9.

In one embodiment, at least two of the at least two metal or metalloid-containing compounds are present at approximately equimolar concentration in the precursor composition.

Generally, the atomic percentage of one of the metals or metalloids, with reference to the total amount of metals and metalloids in the precursor composition, is between about 99.95% to about 0.05%. In some preferred embodiments the atomic percentage of one of the metals or metalloids with reference to the total amount of metal and metalloids is between about 1% and about 99%, including about: 1%, 5%, 10%, 20%, 30%, 40%, 50%, 60%, 70%, 80%, 90%, 95%, and 99%.

The effective minimum amount or concentration of one of the at least two metal or metalloid-containing compounds in a precursor composition of the invention may be related to the degree of difference of PZC between the metal or metalloid-containing compounds. That is, if the difference in PZC between at least two of the metal or metalloid-containing compounds is relatively large, the minimum relative effective amount or concentration of one of said metal or metalloid-containing compounds may be relatively low.

In some preferred embodiments, the at least two metal or metalloid containing compounds of the precursor composition comprise respective metals or metalloids selected from the following groups:

(a) silicon and aluminium

(b) silicon and zirconium

(c) silicon and boron

(d) silicon and titanium

(e) silicon and tin

(f) silicon and zinc

(g) silicon and magnesium

(h) silicon and cerium

(i) aluminium and boron

(j) aluminium and titanium

(k) aluminium and cerium

(l) silicon, aluminium, and boron

(m) silicon, aluminium, and titanium

(n) silicon, aluminium, and tin

(o) silicon, aluminium, and cerium

(p) silicon, aluminium, titanium, tin, zirconium, and boron

As hereinabove described, in a metal or metalloid-containing compound according to the process of this aspect of the invention, each of these metal or metalloids may independently be combined, as appropriate, with any suitable compound-forming moieties. In this regard, with reference to the examples, it has been observed that a range of compound-forming moieties are suitable for use in metal or metalloid-containing compounds of the invention. It is believed that any compound-forming moiety which allows for interaction in the precursor composition of a respective metal or metalloid of the metal or metalloid-containing compound, with a respective different metal of another metal or metalloid-containing compound, is potentially suitable for the process of this aspect.

Generally, said moiety may be selected from the group of MH, MOH, MR, and MOR, where M represents a metal or metalloid, O is oxygen, H is hydrogen, and R is an organic group.

In certain embodiments, said moiety is selected from the group consisting of halide, halogen, alkoxide, alkyl, hydroxyl, hydrogen, acyloxy, alkoxy, and acetyl.

Preferably, at least one of the metal or metalloid-containing compounds of this aspect has at least two groups being either hydrolysable and/or condensable. It will be appreciated that the presence of at least two hydrolysable and/or condensable groups on at least one of said compounds is strongly beneficial to facilitate assembly of said compounds into the solid network structure of a mixed metal oxide solid of the invention.

It will be appreciated that in embodiments of the invention wherein one or more of the at least two compounds have only a single hydrolysable and/or condensable group, these compounds may be incorporated into a network in a ‘pendant’ bonding formation, providing at least one of the metal or metalloid-containing compounds of this aspect has at least two hydrolysable and/or condensable groups. The pendant bonding metal or metalloid-containing compound may be chosen to impart specific properties, such as a hydrophobic surface in one non-limiting example, upon the mixed metal oxide solid.

In particularly preferred embodiments, each of the at least two metal or metalloid-containing compounds has at least two hydrolysable and/or condensable groups. The presence of at least two hydrolysable and/or condensable groups on each of said compounds can facilitate enhanced interconnection or cross-linking between the metal or metalloid-containing compounds in the solid network.

In highly preferred embodiments, at least one of the at least two metal or metalloid-containing compounds has at least three, even more preferably at least four hydrolysable and/or condensable groups. This can result in a mixed metal oxide solid with particularly desirable properties with respect to, by way of non-limiting example, morphological characteristics and/or stability including a highly cross-linked final mixed metal oxide solid.

Preferably, the metal or metalloid-containing compounds are alkoxides, or have other groups attached by way of a bridging oxygen. Such metal or metalloid-containing compounds can be particularly effective for hydrolysing and/or condensing and reacting according to step (ii) of the process of this aspect.

However, as hereinabove described, it will be appreciated that the at least two metal or metalloid-containing compounds need not necessarily be metal or metalloid alkoxides. Suitably, in embodiments wherein one or more of the at least two metal or metalloid-containing compounds are not alkoxides or other oxygen-containing compounds, such as for example a metal halide, said compound(s) may initially obtain an oxygen from the solvent molecules or amounts of water within the precursor composition, prior to, or as part of the process of, reacting according to step (ii) of the process. That is, a non-oxygen containing compound, such as titanium tetrachloride, may first hydrolyse to form for example titanium trichloride monohydroxide or at least partially do so, prior to then reacting with the further metal or metalloid-containing compound to form the mixed metal oxide solid. Additionally, certain metal or metalloid-containing compounds may directly condense to form a metal oxide network during the process of this aspect, for example by reacting at a hydroxyl site already present within the forming network or at the substrate.

Each of the respective metal or metalloid-containing compounds of this aspect may be a monomer or an oligomer. In certain preferred embodiments wherein at least one of the metal or metal or metalloid-containing compounds is an alkoxide, the metal or metalloid alkoxide is an oligomer. The use of such an oligomer can facilitate ease and safety of handling.

In some preferred embodiments, the precursor composition is coated onto a further material or substrate according to the process of this aspect. As used herein, the term “substrate” will be understood to refer generally to material onto which the mixed metal oxide film of the invention may form. The precursor composition may be coated onto the material or substrate using any of the range of suitable techniques known to those skilled in the art including spray coating, dip coating, spin coating, slot-die application, curtain coating, flow coating, drop casting, and ink-jet application, although without limitation thereto.

In certain preferred embodiments, the material or substrate is selected from the group consisting of crystalline metal oxides; amorphous metal oxides; sapphire; silicon; germanium; a semiconductor material; a plastic; glass such as borosilicate glass, silicon, float glass, cast glass, rolled glass, soda-lime glass; acrylics and acrylates such as poly(methyl methacrylate) and polymethyl methacrylimide; polycarbonate; polyester (e.g. polyethylene terephthalate); metals such as aluminium and copper; and elastomers such as silicone.

In certain preferred embodiments, the material or substrate presents, or can be modified to present, hydrolysable and/or condensable groups at the surface. In some embodiments, the material or substrate may be one which presents, or can be modified to present, an oxygen atom or hydroxyl group at the surface of the substrate. It will be appreciated that a mixed metal oxide solid of the invention can use any hydrolysable and/or condensable groups that are present at the surface of a material or substrate to covalently bond to the material or substrate, typically achieving strong adhesion to the material or substrate.

It will be appreciated that, if covalent attachment of a mixed metal oxide film as described herein to the material or substrate is desired, and the material or substrate does not present an oxygen atom or oxygen-containing moiety or another suitable reactive group at or near its surface for bonding thereto by the forming mixed metal oxide film, then the material or substrate may be chemically or mechanically etched or otherwise manipulated to do so. In one embodiment, the material or substrate may first have a priming layer applied thereto to improve film binding. For example, when the material or substrate is sapphire then the surface thereof may be pre-coated with bis(trimethylsilyl)amine using standard techniques.

However, it will be appreciated that a mixed metal oxide solid of the invention can also potentially be coated onto a material or substrate wherein such surface groups are not present, and this coating will adhere for example by electrostatic or van der Waals forces.

Additionally, in some embodiments wherein substantial or strong adhesion by a mixed metal oxide solid of the invention to the surface of a substrate is not required or desired (by way of non-limiting example, in applications for imprint lithography), materials or substrates with minimally reactive groups at the surface may instead by used, such as for example fluorine or methyl groups or similar.

It will be further understood that the mixed metal oxide solid need not be necessarily coated on any material or substrate, and the process described herein can be used, for example, for casting unattached mixed metal oxide materials.

Preferably, step (i) of the process of this aspect is preceded by the step of combining at least two metal or metalloid-containing compounds to form at least part of the precursor composition. It will be appreciated that each of the at least two metal or metalloid-containing compounds may be in liquid or solid form.

In certain embodiments, solid and/or liquid metal or metalloid-containing compounds may be added to a solvent to form the precursor composition. In preferred embodiments wherein the metal or metalloid-containing compounds are added to a solvent, the metal or metalloid-containing compounds are substantially dissolved in the solvent.

As hereinabove described, preferably, formation of a metal oxide solid according to the method of this aspect does not require a catalyst. Furthermore, it is preferred that no other agents, with the exception of, optionally, water, are required to be added to the precursor composition for formation of the mixed metal oxide solid. As such, it will be appreciated that a mixed metal oxide solid may begin to form according to step (ii) of the process soon after the precursor composition is formed.

It will be understood that the rate of formation of the mixed metal oxide solid may be modulated by the degree of difference in PZC between the metal or metalloid-containing compounds used according to the process of this aspect, with reference to Example 8 and as hereinabove described. Furthermore, without limitation the rate of formation of the mixed metal oxide solid may be modulated by: choice of metal or metalloid-containing compounds; choice and/or amount of solvent(s); and concentration or amount of the compounds in the precursor composition.

In particular regard to concentration and/or amount of the compounds in the precursor solution, it will be appreciated that higher concentrations and/or amounts of the at least two compounds also generally result in more rapid formation of mixed metal oxide solids. In this regard it is postulated that the dilution effect of solvent can assist in controlling the rate of reaction. As the solvent evaporates or is deliberately removed the reaction rate will increase as the at least two different metal or metalloids will come into contact in greater numbers and the hydrolysis and/or condensation reactions occur.

In some embodiments, formation of the mixed metal oxide solid as per the process of this aspect is complete within less than 8 hours after obtaining the precursor composition, including less than: 7 hours, 6 hours, 5 hours, 4 hours, 3 hours, and 2 hours. In some preferred embodiments, formation of the mixed metal oxide solid is complete less than 90 minutes after obtaining the precursor composition, including less than: 80 minutes, 70 minutes, 60 minutes, 50 minutes, 40 minutes, 30 minutes, 20 minutes, 10 minutes, 5 minutes, 2 minutes, and 1 minute.

It will be appreciated that, in embodiments of the process of this aspect wherein the mixed metal oxide solid is deposited on or applied to a further material or substrate, it is typically desirable to minimise reaction of the metal or metalloid-containing compounds of the precursor solution prior to deposition on the material or substrate. In one preferred embodiment, the precursor composition applied to or deposited on the material or substrate as soon as possible after obtaining the precursor composition. In some embodiments, the precursor composition is applied to or deposited on the material or substrate less than 90 minutes after obtaining the precursor composition, including less than: 80 minutes, 70 minutes, 60 minutes, 50 minutes, 40 minutes, 30 minutes, 20 minutes, 10 minutes, 5 minutes, 2 minutes, and 1 minute.

In this regard, one difference between the present process and traditional sol-gel processes is that the present process does not require any minimum holding time between combining the at least two metal or metalloid-containing compounds and application to a further material or substrate. This is because the reaction can start immediately upon mixing, with the rate dependent on the factors previously discussed, without requiring ageing of the precursor composition or ripening of colloidal particles as with sol-gel approaches. Therefore, in one embodiment, the precursor composition does not require any substantial time delay before application to a further material or substrate.

It will be further understood that the environmental conditions to which the precursor composition, or intermediates thereof, are exposed during step (ii) of the process of this aspect may be varied or modified.

In some embodiments, step (ii) of the process of this aspect may be performed at approximately room temperature, i.e. approximately 22° C. In preferred embodiments, step (ii) of the process includes exposing the precursor composition or precursor composition coated substrate to a temperature above room temperature for a period of time, i.e. to “elevated temperature”. Exposure to elevated temperature as per step (ii) of the process of this aspect may decrease the time taken to form a mixed metal oxide solid, and/or produce a mixed metal oxide solid with desirable properties with respect to, by way of non-limiting example, morphological characteristics and/or density and/or stability of the mixed metal oxide solid.

Suitably, exposure to elevated temperature serves to increase the evaporation of a solvent of the precursor composition, but does not substantially affect the chemical process of formation of the mixed metal oxide solid. Such exposure to elevated temperature to increase evaporation of a solvent may nevertheless decrease the time taken to form the mixed metal oxide solid (e.g. by increasing the concentration of the at least two metal or metalloid-containing compounds in the precursor composition), and/or achieve desirable properties (e.g. rapid evaporation of a solvent may result in a solid with ‘layered’ density, for example, in the context of a film, an increased density at a surface via which evaporation is occurring as compared to within the body of the film).

The temperature of said elevated temperature may vary. However, it will be appreciated that the upper limit of the temperature will suitably be below the temperature of decomposition of the least stable metal or metalloid-containing compound of the precursor composition of the process of this aspect. Additionally, it is desirable that the maximum temperature be less than that which would be employed in sintering the material, e.g. as performed during sol-gel methods.

In some embodiments the elevated temperature is between about 20° C. and about 1200° C. Preferably the elevated temperature is between about 40° C. and 700° C. More preferably the elevated temperature is less than 400° C.

In certain embodiments, the elevated temperature is about 50° C. to about 250° C., including about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., and about 240° C.

Preferably, the elevated temperature is about 70° C., about 80° C., about 90° C., about 100° C., about 110° C., about 120° C., about 130° C., about 140° C., about 150° C., about 160° C., or about 170° C.

In certain embodiments, the duration of exposure of the precursor composition or precursor composition coated substrate to elevated temperature may be between about 1 minute and about 240 minutes, including about: 10 minutes, 20 minutes, 30 minutes, 40 minutes, 50 minutes, 60 minutes, 70 minutes, 80 minutes, 90 minutes, 100 minutes, 110 minutes, 120 minutes, 130 minutes, 140 minutes, 150 minutes, 160 minutes, 170 minutes, 180 minutes, 190 minutes, 200 minutes, 210 minutes, 220 minutes, and 230 minutes.

In other embodiments, the duration of exposure to elevated temperature may be about 24 hours, or greater.

Preferably the duration of exposure to elevated temperature is less than about 30 minutes, including less than about: 29 minutes, 28 minutes, 27 minutes, 26 minutes, 25 minutes, 24 minutes, 23 minutes, 22 minutes, 21 minutes, 20 minutes, 19 minutes, 18 minutes, 17 minutes, 16 minutes, 15 minutes, 14 minutes, 13 minutes, 12 minutes, 11 minutes, 10 minutes, 9 minutes, 8 minutes, 7 minutes, 6 minutes, 5 minutes, 4 minutes, 3 minutes, 2 minutes, and 1 minute.

In particularly preferred embodiments, step (ii) of the process is performed partially at room temperature, and completed by exposure to elevated temperature as hereinabove described. Preferably, the duration of step (ii) of the process that occurs at room temperature is between about 10 seconds and about 30 minutes, including about: 30 seconds, 1 minute, 2 minutes, 3 minutes, 4 minutes, 5 minutes, 10 minutes, 15 minutes, 20 minutes, and 25 minutes.

Suitably, step (ii) of the process of this aspect may be performed at or near standard atmospheric pressure, i.e. ˜100 kPa. In some embodiments, step (ii) is performed at conditions of altered pressure, i.e. pressure different than ˜100 kPa, including conditions of increased pressure, and conditions of decreased pressure.

Preferably, in embodiments wherein step (ii) is performed under conditions of increased pressure, said pressure is between about 110 and about 500 kPa, including about: 150 kPa, 200 kPa, 250 kPa, 300 kPa, 350 kPa, 400 kPa, and 450 kPa.

Preferably, in embodiments wherein step (ii) is performed under conditions of decreased pressure, said pressure is between about 0.1 Pa and about 10 kPa. In some preferred embodiment said pressure is between about 0.1 Pa and about 100 Pa, including about: 1 Pa, 10 Pa, 20 Pa, 30 Pa, 40 Pa, 50 Pa, 60 Pa, 70 Pa, 80 Pa, and 90 Pa.

The process of this aspect may include a further step of controlling one or more characteristics of the mixed metal oxide solid by selecting or adjusting various parameters, examples of which parameters are set forth below. Preferably, in embodiments of the process which include said further step of controlling one or more characteristics of the mixed metal oxide solid by selecting or adjusting certain parameters, said characteristics are physical and/or morphological and/or optical and/or electrical and/or thermal and/or chemical characteristics.

Preferably, said physical characteristics are selected from the group consisting of strength, hardness, scratch resistance, cohesion, adhesion, plasticity, elasticity, stiffness, and density.

Preferably, said morphological characteristics are selected from the group consisting of porosity, particle size, surface texture, layer thickness, roughness, moulded or embossed pattern, and conformality.

Preferably, said optical characteristics are selected from the group consisting of transparency, transmission, reflection, refractive index, dispersion, absorption, scattering, and optical interference.

Preferably, said electrical characteristics are selected from the group consisting of resistance, conductance, dielectric breakdown, and dielectric constant.

Preferably, said thermal characteristics are selected from the group consisting of thermal expansion, heat conduction, melting temperature, and heat capacity.

Preferably, said chemical characteristics are selected from the group consisting of chemical resistance including acid and alkali resistance, resistance to dissolution, stability in water including salt water, resistance to steam, ability to resist degradation by solvents, ability to be further surface modified, surface energy, hydrophobicity, hydrophilicity, oleophobicity, oleophilicity, functionalisation, redox potential, thermal catalysis, photocatalysis, and surface groups.

In one preferred embodiment, the combination of the at least two metal or metalloid-containing compounds is selected to control said characteristics of the mixed metal oxide solid. By way of non-limiting example, in regard to embodiments of the invention wherein the at least two metal or metalloid-containing compounds include a silicon containing compound:

(i) the inclusion of a titanium containing compound can result in solids, such as films, with relatively high refractive index;

(ii) the inclusion of cerium can result in solids, such as films, with relatively high absorption of UV light;

(iii) the inclusion of aluminium can result in solids, such as films, with relatively high refractive index and relatively low surface energy; and

(iv) the inclusion of aluminium and boron can result in lower refractive index as compared to silicon and aluminium alone.

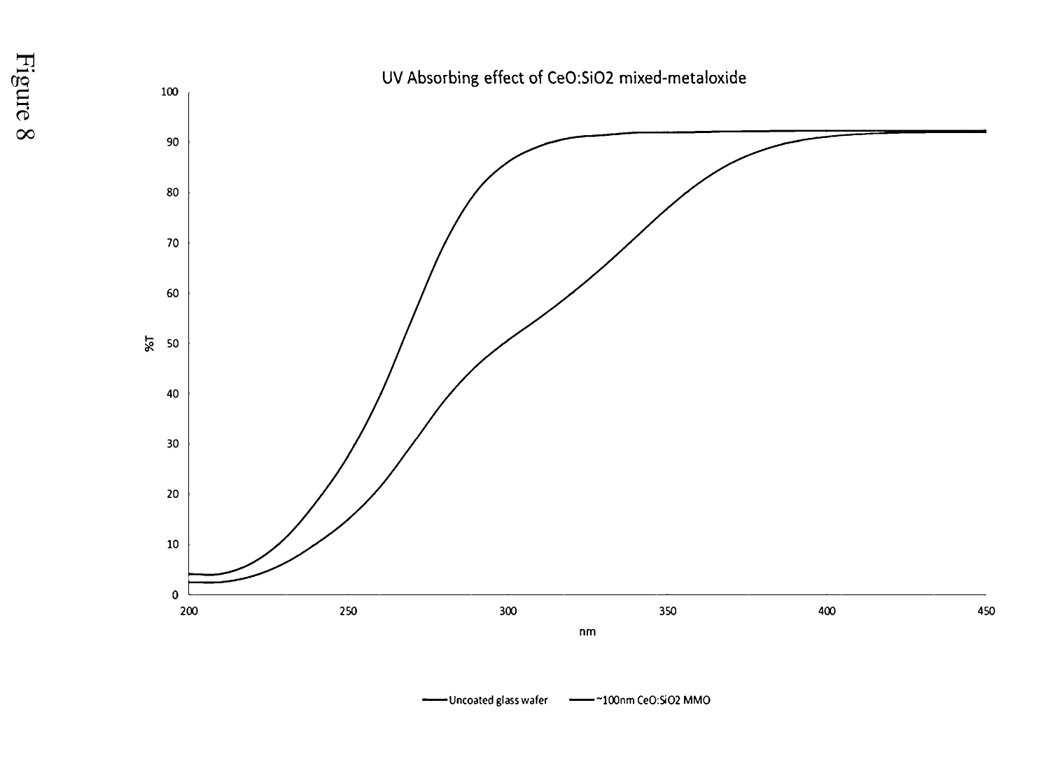

In particular regard to (ii), above, FIG. 8 sets forth an example of increased UV absorption by a mixed metal oxide film formed by the process of the invention which contains cerium.

Additionally or alternatively, the solvent type and/or the solvent content of the precursor composition may be selected to control said characteristics of the mixed metal oxide solid. By way of non-limiting example, using methyl ethyl ketone generally results in a lower density solid than ethanol.

Additionally or alternatively, the environmental conditions during step (ii) of the process may be selected to control said characteristics of the mixed metal oxide solid. By way of non-limiting example, exposing the precursor composition to elevated temperature generally results in mixed metal oxide solids, such as films, with higher density and higher refractive index. Additionally, exposing the precursor composition to decreased pressure generally results in solids, such as films, with increased density, whereas exposing the precursor composition to increased pressure generally results in decreased density.

Additionally or alternatively, in embodiments wherein the precursor composition is coated on or applied to a material or substrate, the material or substrate may be selected to control the characteristics of the mixed metal oxide solid.

Additionally or alternatively, in embodiments wherein the precursor composition is coated on or applied to a material or substrate which has been treated with a primer, the primer or method of priming may be selected to control the characteristics of the mixed metal oxide solid.

Additionally or alternatively, one or more additives may be included in the precursor composition to control the characteristics of the mixed metal oxide solid, such as drying control agents, porogens, and templating agents, although without limitation thereto. By way of non-limiting example, the addition of a porosity-forming additive (porogen) to a precursor composition of the invention can form a mixed metal oxide solid with substantially increased porosity as compared to a mixed metal oxide solid formed from a corresponding precursor composition without the addition of the porosity-forming additive, and which may have a relatively low refractive index, particularly in the context of a solid that is a film. In some preferred embodiments, a mixed metal oxide solid formed from a precursor composition without the addition of a porosity-forming additive features limited or absent porosity.

It will also be appreciated that molecules and particles such as (by way of non-limiting example) dyes or phosphors, fragrance molecules, pharmaceuticals, and biocides, can potentially be contained within a pore structure of prior art metal oxide films. This process is generally referred to as ‘doping’ or ‘hosting’.

Certain embodiments of the mixed metal oxide solid of the invention featuring a substantially porous structure may be subject to doping or use as a host. Preferably, doping of a mixed metal oxide solid, such as a film, of the invention is performed by adding a desired molecule or molecules (or ‘dopant’) to the precursor composition as per the process of this aspect. In some preferred such embodiments of the process of this aspect, the precursor composition is added to a powder or slurry of the material to be hosted.

### Mixed Metal Oxide Solids and Uses Thereof

The invention also provides for mixed metal oxide solids produced according to the previous aspect.

Furthermore, the invention provides mixed metal oxide films formed by obtaining a precursor composition comprising at least two metal-containing compounds, wherein the metal or metalloids of the at least two compounds are different, one from the other; and allowing the at least two metal-containing compounds to at least partially hydrolyse and react.

The invention also provides the aforementioned mixed metal oxide solids for use or when used for a particular application, which application may involve applying the mixed metal oxide film to another material. With reference to the examples, it will be appreciated that mixed metal oxide solids as described herein can be suitable to apply to a range of substrates or materials. Without limitation, said applications include one or more of:

(a) as a coating;

(b) as an adhesive;

(c) as a barrier;

(d) as a binder;

(e) as an encapsulant;

(f) for adjusting optical properties of a material.

In regard to use of the mixed metal oxide solid as an adhesive, it will be appreciated that mixed metal oxide solids of the invention may also be used to bind respective surfaces of one or more substrates or materials. In this regard, if a mixed metal oxide solid, such as a film, is formed between two materials which both display suitable reactive groups (or are suitably primed as described previously) then the forming solid will bond to both substrate surfaces thereby adhering the substrates. It will therefore be appreciated that a mixed metal oxide solid may act as an adhesive between substrates or materials of the same or different material.

In regard to use of the mixed metal oxide solid as a barrier, it will be appreciated that the solid, such as a film, may be applied or coated to a material or substrate to protect and/or restore a surface of the material or substrate (e.g. a protective and/or restorative barrier) for said substrate. In this regard, it will be appreciated that the porosity and density of the mixed metal oxide solids may be controlled, as hereinabove described.

In regard to use of the mixed metal oxide solid as a binder and/or encapsulant, in some embodiments, the mixed metal oxide solid may be used in cermets. Said mixed metal oxide films may be particularly useful as dielectric materials in cermets.

By way of non-limiting example, nano-scale particles of silver or gold or copper or aluminium may be dispersed in mixed metal oxide films, such that the resulting cermet material displays desired optical properties, such as selective absorption of light. Additionally, in some embodiments, the mixed metal oxide solid of the invention may be used to attach phosphors to LED dies. In preferred such embodiments, mixed metal oxide films are doped with a suitable phosphor, and coated on the surface of an LED die. In another preferred embodiment a suitable mixed metal oxide film is used to adhere a phosphor piece to the surface of a LED die.

In regard to use of the mixed metal oxide solid for adjusting optical properties of a material, in some embodiment mixed metal oxide solids, particularly films, may be used as an antireflective coating for a substrate. In other embodiments, mixed metal oxide solids may be used as a reflective coating for a substrate. In this respect, it will be appreciated that the refractive index of mixed metal oxide solids such as films of the invention may be controlled, as hereinabove described. It will be further appreciated that mixed metal oxide solids such as films of the invention may have, respectively, light scattering or non-scattering properties. By way of non-limiting example, and as will be understood by the skilled person, light scattering properties may be induced by: producing large pores which act as scattering centres; providing for a film to have high stresses which will manifest as scattering centres; and/or by the addition of scattering material such as e.g. opaque particles or particles having a higher or lower refractive index than the film. It will be appreciated that in some embodiments the antireflective coating also acts as a barrier, such as a protective barrier for a substrate such as glass.

Also provided according to this invention is an article comprising a substrate or material coated with or otherwise attached to a mixed metal oxide film as described herein. Some preferred such articles include glass (e.g. annealed glass, float glass, cast glass, tempered glass, or laminated glass), or articles comprised of glass, although without limitation thereto. Particular non-limiting examples of coated articles of the invention include windows and windscreens, eyeglasses, optical devices, LED dies, lighting fixtures and luminaires, automotive parts, semiconductor devices, printed circuits, and electronic devices, plastic articles, metal surfaces, lenses, mirrors, and silicon wafers.

In order that the invention may be readily understood and put into practical effect, particular preferred embodiments will now be described by way of the following non-limiting examples.

### EXAMPLES

### Example 1: Production of Mixed Metal Oxide Solids

Mixed metal oxide solids, in the form of films coated on a borosilicate glass substrate, were produced using the following combinations of reagents:

### Group a Two-Part Materials:

polymethoxysiloxane (MS-51)/aluminium tri-sec-butoxide
polymethoxysiloxane/zirconium propoxide
polymethoxysiloxane/boron triethoxide
polymethoxysiloxane/titanium butoxide
polymethoxysiloxane/tin 2-ethylhexanoate
polymethoxysiloxane/zinc methoxide
polymethoxysiloxane/magnesium methoxide
polymethoxysiloxane/cerium 2-methoxyethoxide
aluminium tri-sec-butoxide/boron triethoxide
aluminium tri-sec-butoxide/titanium butoxide
aluminium tri-sec-butoxide/cerium 2-methoxyethoxide

### Group B Three Part Materials:

polymethoxysiloxane/aluminium tri-sec-butoxide/boron triethoxide
polymethoxysiloxane/aluminium tri-sec-butoxide/titanium butoxide
polymethoxysiloxane/aluminium tri-sec-butoxide/tin 2-ethylhexanoate
polymethoxysiloxane/aluminium tri-sec-butoxide/cerium 2-methoxyethoxide
Group C six part materials:
polymethoxysiloxane/aluminium tri-sec-butoxide/titanium butoxide/tin 2-ethylhexanoate/zirconium propoxide/boron triethoxide

The procedure for the formation of the mixed metal oxide films was as follows:

Steps 1-2 below were performed in a glovebox purged with nitrogen gas.

Step 1. To a glass beaker were added:
0.390 g butanone
0.640 g 2-butoxyethanol
Metal/metalloid precursors to 10% w/w concentration
   The metal/metalloid precursors were combined in the following ratios:
Group A 3.444:1
Group B 6.89:1:1
Group C 1:1:1:1:1:1

Step 2. The solution prepared in Step 1 was thoroughly mixed by stirring, and deposited onto a wafer of floated borosilicate glass (Schott BOROFLOAT 33 ®). The wafer was then left to stand for 10 minutes under ambient conditions.

Step 3. The coated wafer was then baked in a gravity convection oven for 15 minutes at a temperature of 130° C.

The properties of the mixed metal oxide film produced according to Steps 1-3 were then assessed, as set forth in EXAMPLE 2, below.

### Example 2: Properties of Mixed Metal Oxide Films

Mixed metal oxide films produced as set forth in EXAMPLE 1 were subjected to assessment as follows.

Cohesion and Adhesion.

The following tests for cohesive and adhesive properties of the mixed metal oxide films were performed. (1) wipe tests of the films with cloth, both dry and under water; (2) rinse tests (samples were rinsed under running water and inspected to see if films had been removed or damaged); (3) crocking tests according to EN1096.2; (4) tape tests according to ASTM D3359-09. Results are set forth in Tables 1-3.

Durability Testing.

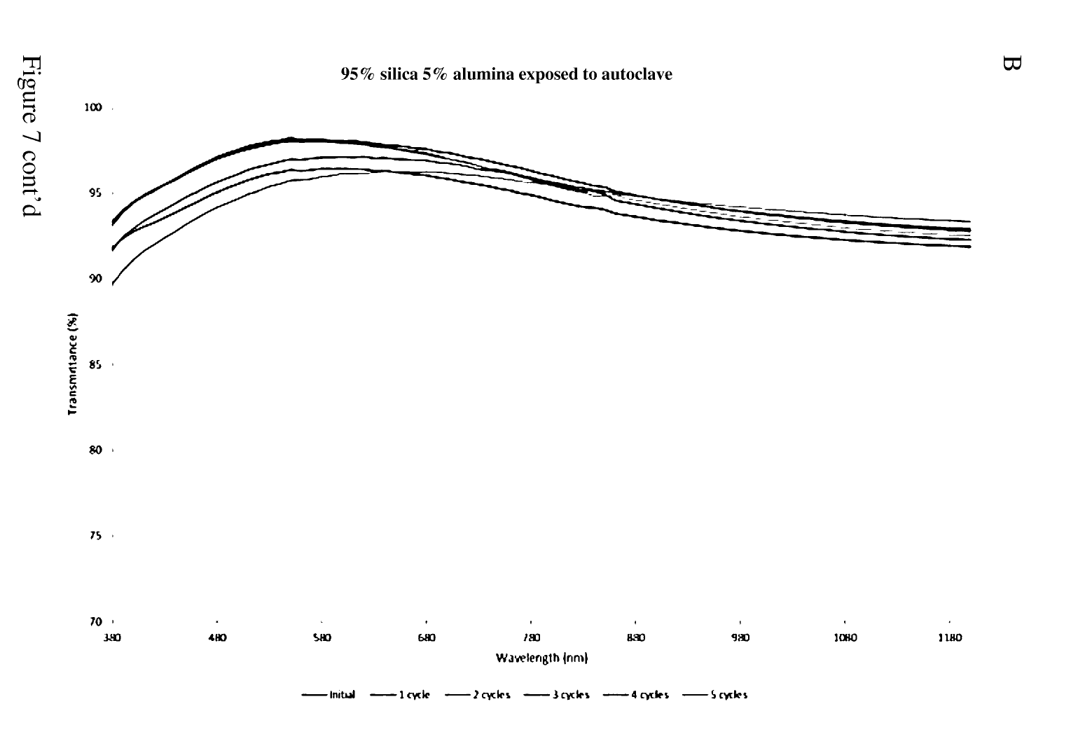

Accelerated durability testing of the films was performed in environmental chambers. Films were exposed to thermal cycling, damp heat, humidity freezing, and UV radiation according to IEC61215, IEC61646, JESD22-A. The films were also subjected to testing by autoclave exposure. Exemplary results are given in FIG. 7.

Morphological Testing.

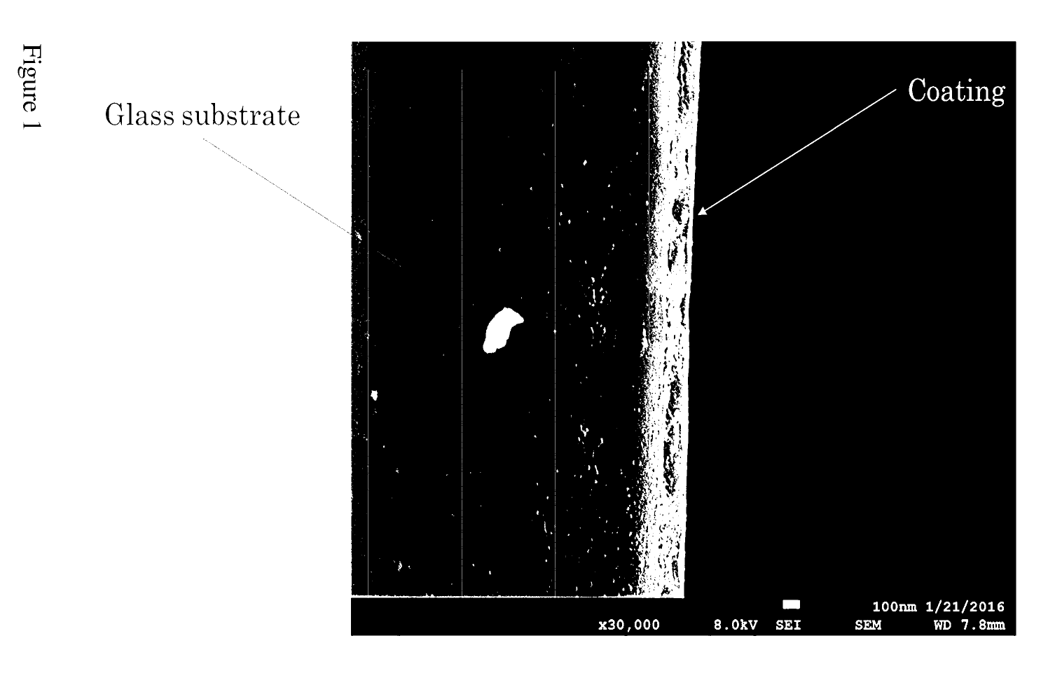

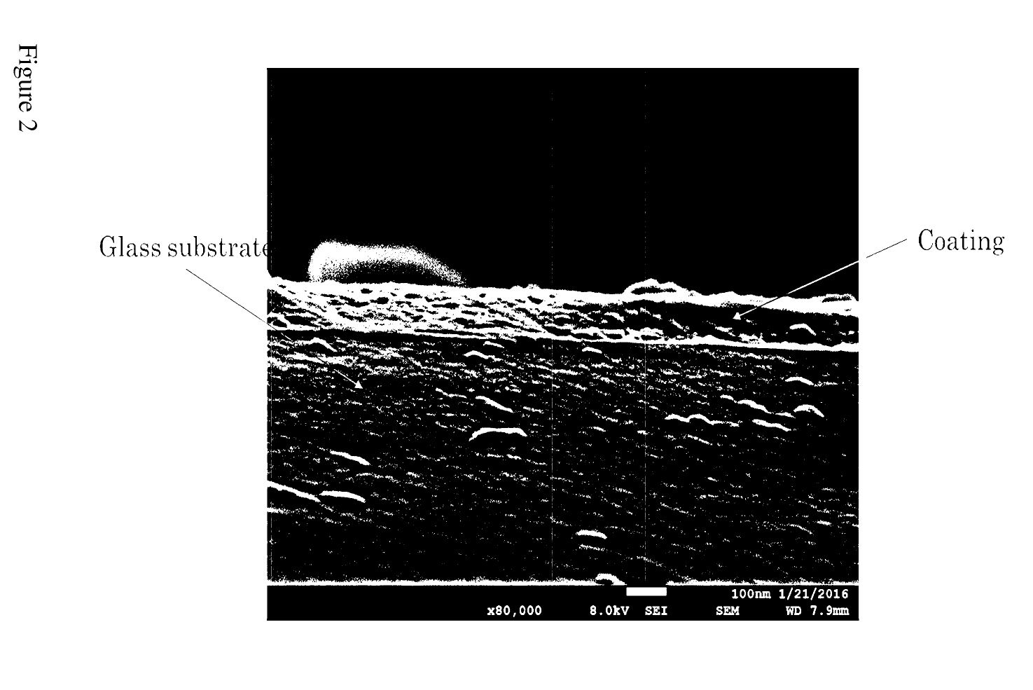

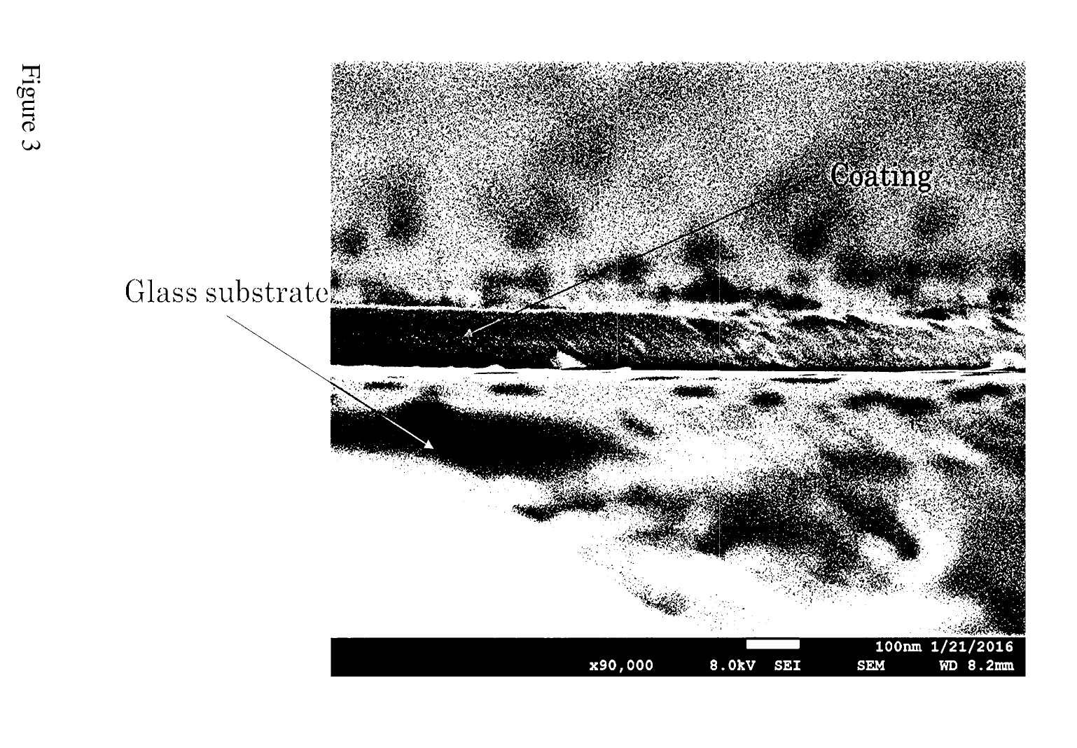

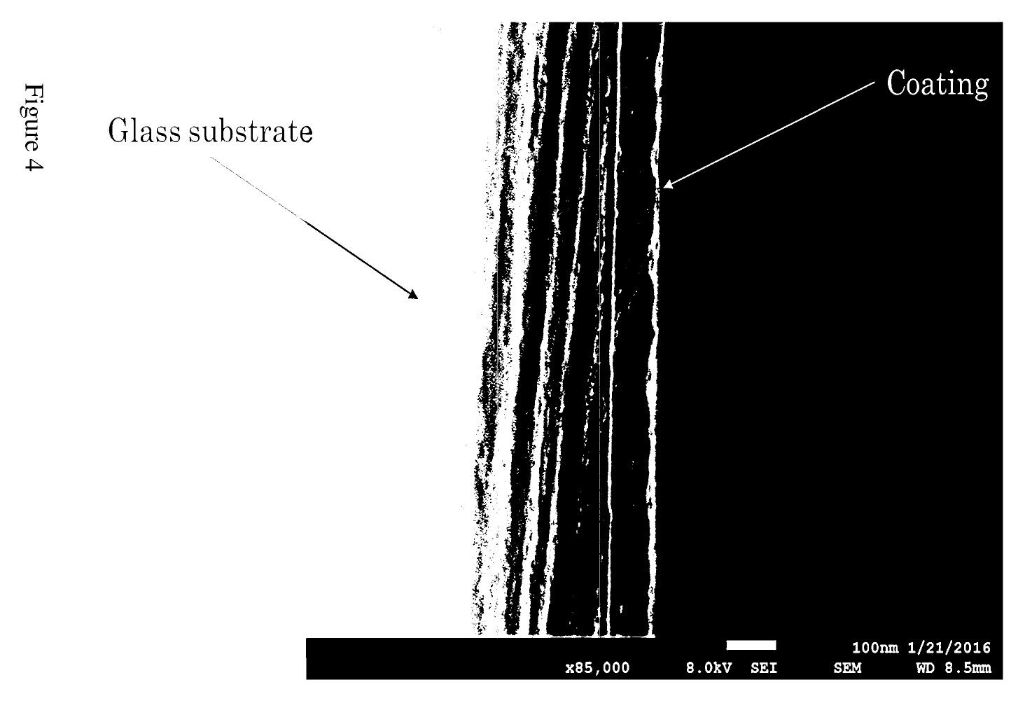

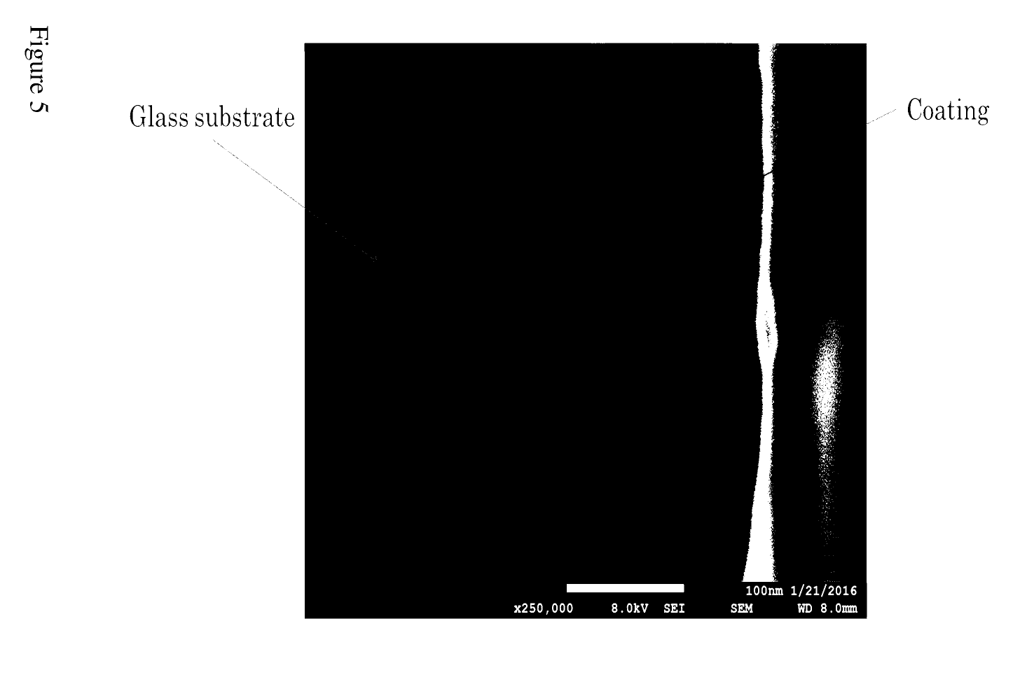

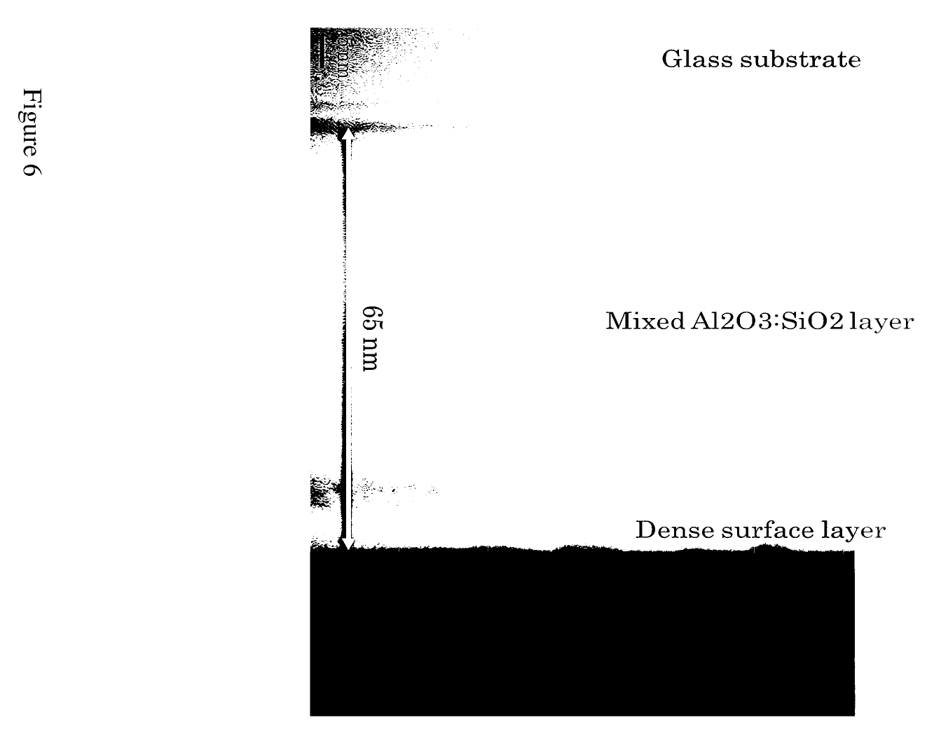

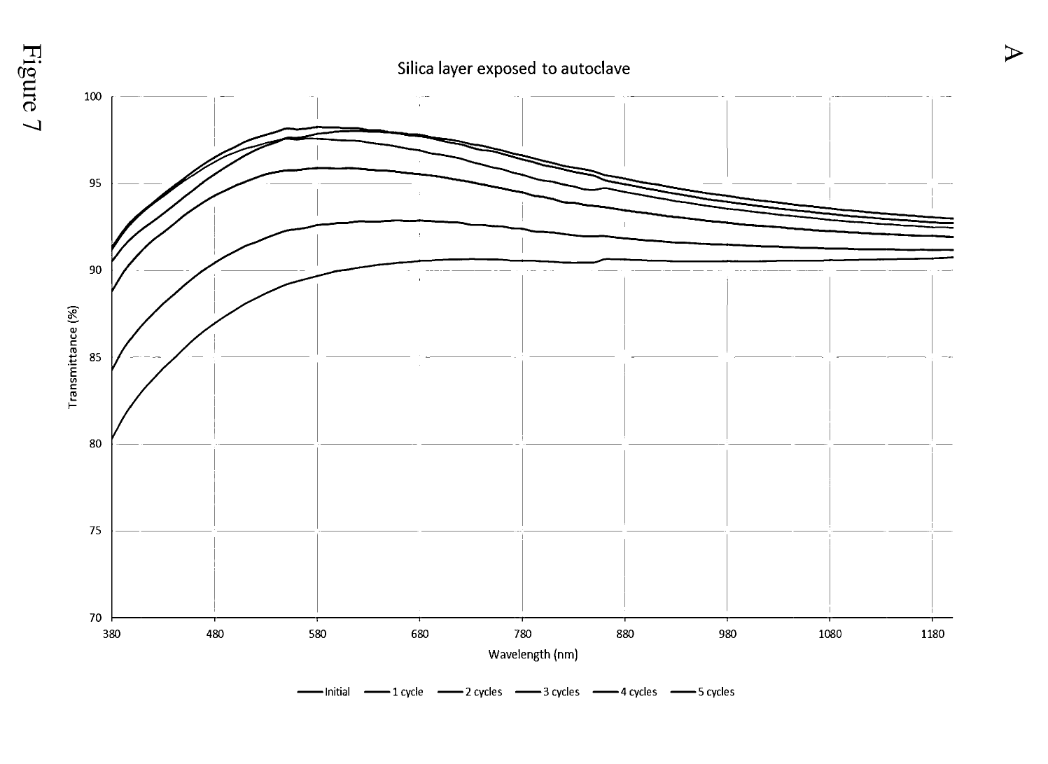

The structure of the solid network of the films was assessed by Scanning Electron Microscopy (SEM). Additionally, surface texture was assessed by Atomic-Force Microscopy (AFM). Exemplary results are given in FIGS. 1-5.

Compositional Testing.

The elemental composition of the films was assessed by X-ray Photoelectron Spectroscopy (XPS). The XPS analysis revealed that the compositions of the films were uniform and agreed with the expected composition based on starting materials.

Optical Testing.

Refractive Index and light scattering properties of the films were assessed using UV/Vis spectrophotometry.

### Example 3. Effect of Elevated Temperature on Mixed Metal Oxide Solid Formation

The effect of temperature on the formation of a mixed metal oxide solids, in the form of a films, from a precursor composition comprising polymethoxysiloxane/aluminium tri-sec-butoxide was assessed. For these experiments, the mixed metal oxide films were prepared in a similar manner as that described in EXAMPLE 1. However, the temperature as per Step 3 was varied. Temperatures of ˜22° C. (i.e. room temperature), 50° C., 90° C., 130° C., 150° C., and 170° C. were tested, as set forth in Table 6.

Mixed metal oxide films were successfully formed under all temperature conditions. However, the formation of the mixed metal oxide films took substantially longer at temperatures of ˜22° C. and 50° C. thereby indicating that elevated temperature is not essential but may be useful, in a commercial setting, to decrease the duration of the film forming process. Nevertheless, repeat experiments showed that under all temperature conditions, formation of the mixed metal oxide film was complete within 90 minutes. It was also observed that there does not appear to be any upper boundary for duration for the exposure to heat, i.e. increased durations of temperature treatment did not substantially affect the properties of the films.

### Example 4. Coating of Various Substrates with Mixed Metal Oxide Film

The ability of mixed metal oxide films formed from a precursor solution comprising polymethoxysiloxane/aluminium tri-sec-butoxide to coat onto substrates was assessed. For these experiments, the mixed metal oxide film was prepared in a similar manner as that described in EXAMPLE 1. However, the mixture was deposited onto a different substrate as per Step 2. Mixed metal oxide films were found to successfully form on silicon wafer, sapphire, float glass, rolled glass, cast glass, borosilicate, fused silica, germanium, acrylics and acrylates such as poly(methyl methacrylate), polymethyl methacrylimide, polycarbonate, polyethylene terephthalate, sheet aluminium, sheet copper, silver, and silicone.

### Example 5. Formation of Mixed Metal Oxide Solids in the Absence of Solvent

Starting with polymethoxysiloxane and aluminium tri-sec-butoxide as per Example 1, but no solvent, a pipette was used to place one drop of the polymethoxysiloxane onto a glass wafer, then with a fresh pipette a drop of the Al precursor was placed on top of the polymethoxysiloxane drop. These were then placed in an oven at 90° C. for 10 minutes, after which the droplets were observed to have formed a solid of glassy appearance identical to that made by the method of Example 1 when a solvent was used. However, the solid did not spread as well on the surface of the wafer as is observed when an appropriate solvent is used, indicating the use of an appropriate solvent can be beneficial in at least some scenarios.

### Example 6. Assessment of Ability of Individual Metal or Metalloid-Containing Compounds to Form Metal Oxide Solids

It has been surprisingly discovered by the inventors that a precursor composition comprising at least two metal or metalloid-containing compounds can form a mixed metal oxide solid in the absence of added catalysts or additional reagents. As such, the inventors sought to determine if a precursor composition comprising a single metalloid-containing compound, including silicon compounds, might similarly form a metal oxide solid in the absence of additional catalysts or reagents. In this regard, it is well established in the prior art that the formation of a metal oxide solid from a precursor composition comprising only silicon-containing compound(s) requires the use of a catalyst or additional reagent.

The formation of metal oxide solids was attempted in a manner similar to that described in EXAMPLE 1. However, only a single metal- or metalloid-containing compound was added as per Step 1, such that only a single metal- or metalloid-containing compound was present in the precursor composition. Specifically, the following starting metal/metalloid reagents were tested:

Polymethoxysiloxane (MS-51)

Aluminium tri-sec-butoxide

Zirconium(IV) propoxide solution 70% in propanol

Titanium(IV) butoxide

Cerium 2-methoxyethoxide

The remainder of the procedure was completed as described in the EXAMPLE 1. No formation of a solid metal oxide film was observed thereby indicating that at least two compounds containing different metals or metalloids must be present to successfully form the metal oxide solid by the disclosed method.

### Example 7. Effect of Relative Amounts of Different Metals or Metalloids on Formation of the Mixed Metal Oxide Solids

The minimum relative amount of one of the metals or metalloids required to form a mixed metal oxide film of the invention from a precursor composition comprising polymethoxysiloxane/aluminium tri-sec-butoxide was assessed. The formation of mixed metal oxide solids was attempted in a similar manner as that described in EXAMPLE 1. However, the relative concentration of one metal alkoxide was serially decreased, such that samples were produced wherein the atomic percentage was, respectively 0%, 1%, 5%, 10%, 22.5%, 50%. As set forth in Table 5, all concentrations except the 0% concentration successfully formed mixed metal oxide solids. Subsequent testing has determined that concentration of much less than 1% of one or the metal or metalloid-containing compounds can also be suitable, although it is hypothesized that at very low concentration reaction times will increase.

### Example 8. Effect of PZC on Formation of Mixed Metal Oxide Solids

A series of metals were chosen to explore the effect of varying difference in PZC on the formation of solid mixed metal oxide materials by the process described herein. For these experiments, equal moles of two compounds were dissolved in isopropyl alcohol to equal concentrations. Two samples were then prepared from each set of materials: a thin film by casting the liquid onto glass similar as describe in EXAMPLE 1; and a monolith by retaining the liquid in a glass phial.

As set forth in Table 8, all samples eventually formed solid mixed metal oxide materials, either as a powder, a thin film, or flakes. All were found to be solids and non-greasy with no evidence of remaining unreacted precursor or incomplete reaction. Notably however, the time taken for solid formation (monolith experiment) and cracking (thin film experiment) was related to PZC difference of the components.

### Example 9. Use of Mixed Metal Oxide Solids as Adhesives

It has been observed in experiments conducted for this invention that mixed metal oxide solids formed according to the process described herein which contain aluminium will bond to sapphire and other aluminium containing materials and act as a very effective adhesive. Similarly, mixed metal oxide solids containing silicon, aluminium, and several other metals will bond to silica glass and act as a very effective adhesive.

Further to these observations it has been determined that by making a mixed metal oxide containing both silicon and aluminium, the following materials may be effectively bound in any combination (including to themselves): sapphire, glass, fused silica, quartz, and amorphous aluminium oxide.

This appears to be a general characteristic of these mixed metal oxide solids, whereby two or more metal oxide surfaces may be bonded together by a mixed metal oxide layer containing an appropriate choice of complementary metal oxides.

An exemplary procedure for use of mixed metal oxide solids as adhesives was to combine 66 μL of MS-51 with 1 g of anhydrous propan-2-ol. To this solution, 55 μL of an aluminium precursor solution (20 g of 2-butoxyethanol, 13.9 g aluminium-tri-sec-butoxide) was added. The solution was mixed and used immediately. A small quantity (0.1-10 μL) of the bonding solution was added to one substrate. The second substrate was placed on the bonding film, compressed slightly and left for 45 minutes to solidify. The bonded materials were baked at 100° C. for 15 minutes to complete the curing.

### Example 10. Use of Mixed Metal Oxide Solids as Binders and/or Encapsulants

Mixed metal oxide solids as described herein can be used as binders for powdered phosphors and quantum dots in experiments conducted for this invention. For this application, the metals are typically selected to result in optical characteristics (e.g. transparency; absorption), and further adjusted for compatibility with the particular phosphors or quantum dots being held. The mixed metal oxide acts effectively as a host layer to provide mechanical support and positioning of the phosphors or quantum dots.

Additionally, many phosphors and quantum dots suffer from degradation in the presence of oxygen, water, or other compounds encountered in the environments where it is desirable to use phosphors and quantum dots. Following the results of EXAMPLE 11, below, mixed metal oxide materials as described herein are hypothesised to encapsulate these phosphors or quantum dots and provide a barrier which can prevents ingress of the damaging agents.

It will be appreciated that this encapsulating material may also serve the secondary function as a host matrix or binder to mechanically hold the phosphors or quantum dots in place, as described above, or another binding material may be used to hold particles of phosphor/encapsulant or quantum dot/encapsulant.

To encapsulate phosphors, a blend of silicon and aluminium alkoxides were produced. An exemplary procedure involved the blending of 0.880 mL dimethoxydimethyl silane, 0.515 mL MS-51, 0.21 mL aluminium precursor solution (20 g of 2-butoxyethanol, 13.9 g aluminium-tri-sec-butoxide) and 0.05 mL water. This solution was immediately blended with dry phosphor powder the produce a slurry. The slurry was deposited and dried for 2 hours at ambient then baked at 145° C. for 45 minutes.

### Example 11. Use of Mixed Metal Oxide Solids as Anti-Tarnish and/or Protective Layers for Metal Surfaces

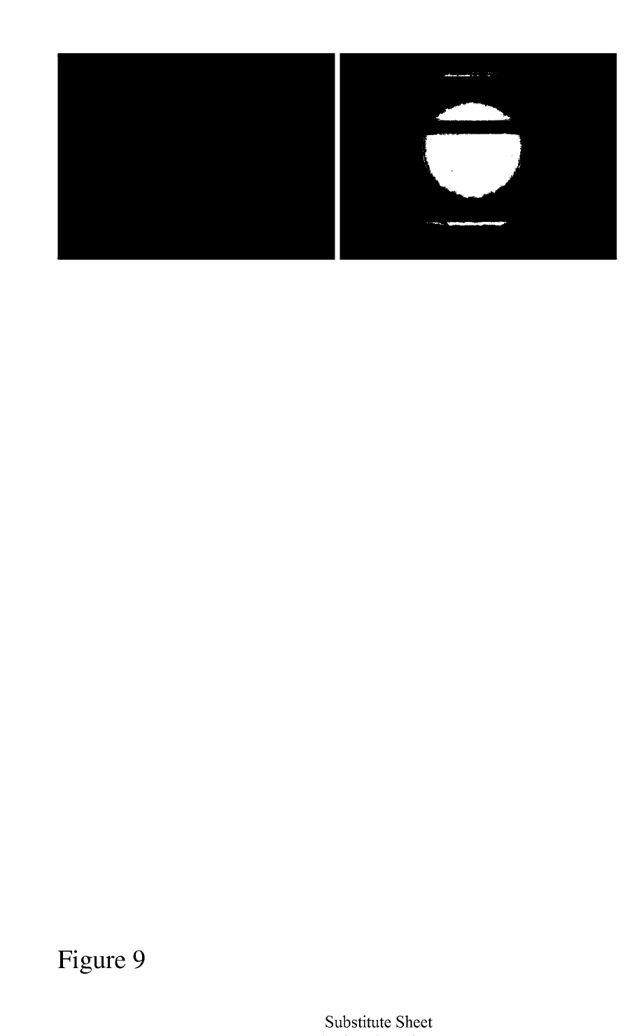

Mixed metal oxide solids as described herein have been successfully used to prevent tarnishing of metallic surfaces in experiments conducted for this invention. Specifically, in the context of LED leadframes, it has been shown that coating of a silver reflector surface with a silicon/aluminium mixed metal oxide film substantially ameliorates tarnishing upon exposure to sulphur for 96 hours (in accordance with ASTM809B testing). See, FIG. 9.

An exemplary procedure for producing anti-tarnish or protective layers on silica is to combine 14.47 g anhydrous propan-2-ol, 0.761 g propylene glycol propyl ether, 79.6 μL zinc oxide dispersion (40% w/w in ethanol, <130 nm diameter), 318 μL MS-51, and 263 μL of an aluminium alkoxide precursor solution (20 g of 2-butoxyethanol, 13.9 g aluminium-tri-sec-butoxide). The solution was mixed and loaded into an appropriate spray gun. The substrates were briefly sprayed using this formulation in a nitrogen atmosphere until all surfaces had been wetted. The substrates were dried for 7 minutes before being baked at 180° C. for 30 minutes.

### Example 12. Use of Mixed Metal Oxide Solids to Modulate Optical Properties

Mixed metal oxide solids as described herein have been successfully used to modulate various optical properties when applied to other materials in experiments conducts for this invention.

Antireflection or High Reflection Layer

Mixed metal oxide solids as described herein may be deposited (by spin coating, spray coating, slot die, etc) as a layer having controlled thickness and the refractive index engineered by the choice of metals and porosity. This layer will then act as an interference layer and can be designed so as to have an anti-reflection or reflection enhancing property, both of which applications have been performed successfully.

To produce this film, precursor solutions of aluminium alkoxide or other metal alkoxide, selected for refractive index or morphology-controlling properties, would be dissolved along with a silica precursor in an appropriate solvent, preferably a low molecular weight alcohol, in amounts ranging from 0 to 100% metal alkoxide. The resulting solution can be sprayed or otherwise deposited onto substrates, yielding films of appropriate refractive index and thickness. The necessary antireflection or high reflection properties are controlled by the relative proportion of the originating precursors, and the thickness of the final coating.

Optical Spacer Layer

For some applications it is desirable to place some optical component, such as a mirror surface, at a distance from where it would otherwise have to be located. The mixed metal oxide material is suited to providing a layer which spaces these components while maintaining mechanical, thermal, and optical properties required in a device. For example, it may be desirable to evaporate a mirrored surface on to the side of an optical light source to enhance the directionality of the source, but to be effective the mirror must be spatially separated from the device. A mixed metal oxide layer of appropriate composition has been successfully used to space a mirror and transmit the light for the purposes of these applications.

It will be appreciated that this application is achieved by using a material of suitable refractive index for the substrate and applying it at an appropriate thickness.

Optical Absorbing Material

By appropriate selection of the metals used to produce a mixed metal oxide solid using the process described herein, particular metal oxides which can be included that will absorb or transmit preferentially at some wavelengths. For example, cerium has been included in a silicon or silicon:aluminium mixed metal oxide to achieve strong absorption of UV light.

An exemplary procedure for producing such UV-absorbing layers is the dissolution of 0.902 g of a cerium precursor solution (12.98 g of cerium methoxyethoxide (18-20% w/w in methoxyethanol) in 0.765 methyl ethyl ketone and 1.25 g 2-butoxyethanol) in 13.4 g ethanol. To this solution 0.719 g MS-51 was added and the resulting solution deposited on glass by spin coating yielding a thin film capable of absorbing light of wavelength less than 400 nm.

Material with Controlled Refractive Index

For many applications, it is desirable to have material where the refractive index is engineered to be a particular value. This is particularly difficult where the desired refractive index is not found in pure materials. By selection of the metals and proportions of metals used in making our mixed metal oxide material refractive index and dispersion of the final mixed metal oxide material has been effectively controlled.

An exemplary process to produce applicable mixed metal oxides, specifically film, in this context is through the combination of a silica alkoxy oligomer with aluminium alkoxides and/or titanium alkoxides. As the relative mass fraction of aluminium and/or titanium increases, the refractive index of the film increases correspondingly. In this way, the refractive index of the film can be controlled.

### Example 13. Use of Mixed Metal Oxide Solids for Planarising/Smoothing/Gap-Filling

In the process of production for some optical devices or LEDs there is sometimes found regions of the device which have surface features such as holes, pits, trenches, scratches, or other topography which is detrimental to the function of the device. The performance of these devices can be improved if these surface features can be repaired, filled in, of if the surface can be made more planar.

In experiments conducted for this invention, it has been determined that mixed metal oxide materials are of particular utility for the above purposed as the underlying device is usually constructed of a metal oxide such as silica or sapphire, or of some metallic species such as silicon or germanium. By appropriate choice of metals for the mixed metal oxide solid a material can be produced which will bond to the underlying device. Furthermore, because the process relies on solution chemistry, surface tension can be exploited to assist with the production of a smooth or conformal layer prior to curing or solidification. Thus, a smoothing of the damaged region can be achieved which can improve the performance of these devices.

Planarisation can be achieved through the spray deposition of a mixture of oligomeric methoxy silane and aluminium alkoxide in low molecular weight alcohol-based solutions. The mixed metal oxide so produced would be dried in ambient or nitrogen environment before a thermal curing step was applied. The resulting film would be continuous to the substrate coated, planarising small-scale pits, fractures, scratches, and other damage.

Throughout the specification, the aim has been to describe the preferred embodiments of the invention without limiting the invention to any one embodiment or specific collection of features. Various changes and modifications may be made to the embodiments described and illustrated without departing from the present invention.

The disclosure of each patent and scientific document, computer program and algorithm referred to in this specification is incorporated by reference in its entirety.

### TABLES

TABLE 1
Summary of precursor compositions comprising two metal or metalloid-
containing compounds used for formation of mixed metal oxide films
as per the invention, and results of assessment of films produced.
‘Self forms’ indicates if a mixed metal oxide film formed (Y[es]
or N[o]). Wipe test; Rinse; and 3M Scotch 810D Tape Test indicates
whether the film past these respective tests (Y or N).

| | Metal/Metalloid | Metal | | | | 810D | |
|---|---|---|---|---|---|---|---|
| | Containing | Atomic | Self | Wipe | | Tape | |
| 2-part | Compound | Fraction | forms | test | Rinse | Test | Notes |
| 10% solids | MS-51 | 100 | N | N | N | N | |
| | MS-51/Aluminium | 77.5/22.5 | Y | Y | Y | Y | |
| | tri-sec-butoxide | | | | | | |
| | MS-51/Zirconium | 77.5/22.5 | Y | Y | Y | Y | |
| | propoxide | | | | | | |
| | MS-51/Boron | 77.5/22.5 | Y | Y | Y | Y | |
| | triethoxide | | | | | | |
| | MS-51/Titanium | 77.5/22.5 | Y | Y | Y | Y | |
| | butoxide | | | | | | |
| | MS-51/Tin 2- | 77.5/22.5 | Y | Y | Y | Y | Very. hazy |
| | ethylhexanoate | | | | | | |
| | MS-51/Cerium 2- | 77.5/22.5 | Y | N | Y | N | |
| | methoxyethoxide | | | | | | |

TABLE 2
Summary of precursor compositions comprising three metal or metalloid-
containing compounds used for formation of mixed metal oxide films as
per the invention, and results of assessment of films produced. ‘Self
forms’ indicates if a mixed metal oxide film formed (Y[es]
or N[o]). Wipe test; Rinse; and 3M Scotch 810D Tape Test indicates
whether the film past these respective tests (Y or N).

| | Metal/Metalloid | | | | | 810D | |
|---|---|---|---|---|---|---|---|
| | Containing | Metal Atomic | Self | Wipe | | Tape | |
| 3-part | Compound | Fraction | forms | test | Rinse | Test | Notes |
| | MS-51/Aluminium | 77.5/11.25/11.25 | Y | Y | Y | Y | seems |
| | tri-sec-butoxide/ | | | | | | moderately |
| | titanium butoxide | | | | | | tough |
| | MS-51/Aluminium | 77.5/11.25/11.25 | Y | Y | Y | Y | seems |
| | tri-sec-butoxide/tin | | | | | | moderately |
| | 2-ethylhexanoate | | | | | | tough, a |
| | | | | | | | few |
| | | | | | | | scratches |
| | | | | | | | from the |
| | | | | | | | wipe |
| | MS-51/Aluminium | 77.5/11.25/11.25 | Y | Y | Y | Y | tough film, |
| | tri-sec-butoxide/ | | | | | | rubbing |
| | cerium 2- | | | | | | with a |
| | methoxyethoxide | | | | | | cloth does |
| | | | | | | | very little |
| | | | | | | | if any |
| | | | | | | | damage |

TABLE 3
Summary of precursor compositions comprising six metal or metalloid-
containing compounds used for formation of mixed metal oxide films
as per the invention, and results of assessment of films produced.
‘Self forms’ indicates if a mixed metal oxide film formed (Y[es]
or N[o]). Wipe test; Rinse; and 3M Scotch 810D Tape Test indicates
whether the film past these respective tests (Y or N).

| | | | | | | | |
|---|---|---|---|---|---|---|---|
| | Metal/Metalloid | | | | | 810D | |
| | Containing | Metal Atomic | Self | Wipe | | Tape | |
| 6-part | Compound | Fraction | forms | test | Rinse | Test | Notes |

| | | | | | | |
|---|---|---|---|---|---|---|
| 10% solids | Si/Al/Ti/Sn/Zr/B | 17/17/17/17/17/17 | Y | Y | Y | Y |

TABLE 4
Summary of precursor compositions comprising two non-silicon metal or
metalloid-containing compounds used for formation of mixed metal oxide
films as per the invention, and results of assessment of films produced.
‘Self forms’ indicates if a mixed metal oxide film formed (Y[es]
or N[o]). Wipe test; Rinse; and 3M Scotch 810D Tape Test indicates
whether the film past these respective tests (Y or N).

| | Metal/Metalloid | Metal | | | | 810D | |
|---|---|---|---|---|---|---|---|
| | Containing | Atomic | Self | Wipe | | Tape | |
| Non-silicon | Compound | Fraction | forms | test | Rinse | Test | Notes |
| 10% solids | Aluminium tri-sec- | 50/50 | Y | Y | Y | N | Hazy |
| | butoxide/boron | | | | | | |
| | triethoxide | | | | | | |
| | Aluminium tri-sec- | 50/50 | Y | N | Y | Y | V. Hazy |
| | butoxide/titanium | | | | | | |
| | butoxide | | | | | | |
| | Aluminium tri-sec- | 50/50 | Y | Y | Y | Y | Continuous |
| | butoxide/cerium 2- | | | | | | clear, soft |
| | methoxyethoxide | | | | | | |

TABLE 5
Summary of formation of mixed metal oxide films
from polymethoxysiloxane/aluminium tri-sec-butoxide
under various temperature conditions, and results
of assessment of films produced. ‘Self forms’
indicates if a mixed metal oxide film formed (Y[es]
or N[o]). Wipe test; Rinse; and 3M Scotch 810D
Tape Test indicates whether the film past these
respective tests (Y or N).

| | | | | | | | |
|---|---|---|---|---|---|---|---|
| | Metal/Metalloid | Metal | | | | 810D | |
| Thermal curing | Containing | Atomic | Self | Wipe | | Tape | |
| boundaries | Compound | Fraction | forms | test | Rinse | Test | Notes |

| | | | | | | |
|---|---|---|---|---|---|---|
| 10% solids | MS-51/Aluminium | 77.5/22.5 | N | N | N | N |
| | tri-sec-butoxide @ | | | | | |
| | RT (10 min, 15 min) | | | | | |
| | MS-51/Aluminium | 77.5/22.5 | Y | Y | Y | Y |
| | tri-sec-butoxide @ | | | | | |
| | 50 (10 min, 15 min) | | | | | |
| | MS-51/Aluminium | 77.5/22.5 | Y | Y | Y | Y |
| | tri-sec-butoxide @ | | | | | |
| | 90 (10 min, 15 min) | | | | | |
| | MS-51/Aluminium | 77.5/22.5 | Y | Y | Y | Y |
| | tri-sec-butoxide @ | | | | | |
| | 130 (10 min, 15 min) | | | | | |
| | MS-51/Aluminium | 77.5/22.5 | Y | Y | Y | Y |
| | tri-sec-butoxide @ | | | | | |
| | 170 (10 min, 15 min) | | | | | |

TABLE 6
Summary of formation of mixed metal oxide films from
polymethoxysiloxane/aluminium tri-sec-butoxide under
various relative concentrations of the respective compounds.
‘Self forms’ indicates if a mixed metal oxide
film formed (Y[es] or N[o]). Wipe test; Rinse;
and 3M Scotch 810D Tape Test indicates whether the film
past these respective tests (Y or N).

| | | | | | | | |
|---|---|---|---|---|---|---|---|
| | Metal/Metalloid | Metal | | | | 810D | |
| concentration | Containing | Atomic | Self | Wipe | | Tape | |
| boundaries | Compound | Fraction | forms | test | Rinse | Test | Notes |

| | | | | | | |
|---|---|---|---|---|---|---|
| 10% solids | MS- | 100/0 | N | N | N | N |
| | 51/Aluminium | | | | | |
| | tri-sec-butoxide | | | | | |
| | MS- | 95/5 | Y | Y | Y | Y |
| | 51/Aluminium | | | | | |
| | tri-sec-butoxide | | | | | |
| | MS- | 90/10 | Y | Y | Y | Y |
| | 51/Aluminium | | | | | |
| | tri-sec-butoxide | | | | | |
| | MS- | 77.5/22.5 | Y | Y | Y | Y |
| | 51/Aluminium | | | | | |
| | tri-sec-butoxide | | | | | |
| | MS- | 60/40 | Y | Y | Y | Y |
| | 51/Aluminium | | | | | |
| | tri-sec-butoxide | | | | | |

TABLE 7
Point of zero charge values for various metal or metalloid-containing
compounds provided in Fierro 2005 (J.L.G. Fierro, Metal Oxides:
Chemistry and Applications, Aug. 24, 2005, CRC Press).

| Metal Oxide | PZC |
|---|---|
| Silica | 2.0 |
| Titania | 6.3 |
| Tantala | 4.0 |
| Zirconia | 6.7 |
| Ceria | 6.8 |
| Alumina | 8.8 |
| Magnesia | 12.4 |

TABLE 8
Summary of observed effect of differences in PZC
(Δ PZC) on formation of monoliths and thin films.

| | Moles | | Moles | | Observation | Observations |
|---|---|---|---|---|---|---|
| Metal 1 | Metal 1 | Metal 2 | Metal 2 | Δ PZC | Monoliths | Thin film |
| Si | 0.00193 | Ta | 0.00193 | 2 | | Cracks after 15 min |
| Si | 0.00147 | Ti | 0.00147 | 4.3 | | Cracks after 25 min |
| Si | 0.00196 | Al | 0.00196 | 6.8 | Immediately | Cracks after 48 |
| | | | | | reacts to | hours |
| | | | | | suspension and | |
| | | | | | precipitates | |
| Ti | 0.00147 | Al | 0.00147 | 2.5 | Gels ~4 hrs | Cracks immediately |
| | | | | | Solid >48 hrs | |
| Ta | 0.00193 | Al | 0.00193 | 4.8 | Solid ~5 hrs | Cracks within a few |
| | | | | | | minutes |
| Ti | 0.00193 | Ta | 0.00193 | 2.3 | Solid ~48 | Cracks immediately |
| Ti | 0.00147 | Zr | 0.00147 | 0.4 | Gels >5 hrs | Cracks immediately |
| | | | | | Solid ~72 hrs | |

1. A process of forming a mixed metal oxide solid including the steps of:
(i) obtaining a precursor composition comprising at least two metal or metalloid-containing compounds, the metal or metalloid of the at least two compounds being different, one from the other; and;
(ii) allowing the at least two metal or metalloid-containing compounds of the precursor composition to at least partially react by hydrolysis and/or condensation,
to thereby form the mixed metal oxide solid.

2. The process of claim 1, wherein the at least two metal or metalloid-containing compounds have different points of zero charge (PZC).

3. The process of claim 1, wherein the precursor composition further comprises a solvent and/or other carrier liquid.

4. The process of claim 3, wherein the precursor composition is selected from the group consisting of a solution, an emulsion, a colloid, a suspension, or a mixture.

5. (canceled)

6. The process of claim 1, wherein exposure of the precursor composition to a catalyst is not required to induce hydrolysis and/or condensation of the at least two compounds to form the mixed metal oxide solid.

7. The process of claim 1, wherein the addition of agents and/or reagents, other than optionally water, to the precursor solution, is not required to induce hydrolysis and/or condensation of the at least two compounds to form the mixed metal oxide solid.

8. The process of claim 1, wherein the metal or metalloids of the at least two metal or metalloid-containing compounds are selected from the group consisting of silicon, germanium, tin, titanium, zirconium, hafnium, vanadium, niobium, tantalum, chromium, cesium, molybdenum, tungsten, yttrium, magnesium, calcium, strontium, barium, lead, zinc, cadmium, mercury, boron, aluminium, gallium, manganese, cerium, iron, tungsten, boron, ytterbium, tellurium, indium, and combinations thereof.

9. The process of claim 8, wherein at least one of said metal of metalloids is silicon or aluminium.

10. The process of claim 1, wherein each of the metal or metalloid-containing compounds contains a moiety selected from the group consisting of halide, halogen, alkoxide, alkyl, hydroxyl, hydrogen, acyloxy, alkoxy, and acetyl.

11. The process of claim 1, wherein at least one of the metal or metalloid-containing compounds has at least two hydrolysable or condensable groups.

12. The process of claim 11, wherein each of the at least two metal or metalloid-containing compounds has at least three hydrolysable or condensable groups.

13. The process of claim 1, wherein step (i) is preceded by a step of combining at least two metal or metalloid-containing compounds to form the precursor composition.

14. The process of claim 1, wherein step (ii) includes exposing the precursor composition, or an intermediate formed therefrom, to elevated temperature.

15. The process of claim 1, wherein the precursor composition is coated onto a substrate.

16. The process of claim 15, wherein the substrate is selected from the group consisting of crystalline metal oxides, amorphous metal oxides, a sapphire substrate, a silicon substrate, a germanium substrate, a semiconductor substrate, a plastic substrate, a glass substrate, borosilicate glass, silicon, float glass, cast glass, rolled glass, soda-lime glass, acrylics and acrylates, polycarbonate, polyester, aluminium, copper, silicone, and a metal substrate.

17. (canceled)

18. (canceled)

19. The process of claim 1, including the step of adhering a plurality of materials by formation of the mixed metal oxide solid between the plurality of materials, to thereby adhere the plurality of materials.

20. (canceled)

21. (canceled)

22. (canceled)

23. (canceled)

24. (canceled)

25. A mixed metal oxide solid produced according to claim 1.

26. The mixed metal oxide solid of claim 25, wherein said material is coated on, applied to, or otherwise physically connection to a further material.

27. The mixed metal oxide solid of claim 25, wherein said mixed metal oxide solid is substantially homogenous.

28. An article comprising a substrate or material coated with or otherwise in physical connection to with the mixed metal oxide solid of claim 25.
